(19) United States
(12) Patent Application Publication
(10) Pub. No.: US 2003/0216185 A1
(43) Pub. Date: Nov. 20, 2003

(54) Method and system for providing an environment for the delivery of interactive gaming services

(76) Inventor: John A. Varley, San Diego, CA (US)

Correspondence Address: Hazim Hamied Ansari, 14252 Culver Dr., Box 914, Irvine, CA, 92604, US

(21) Appl. No.: 10/337,178

(22) Filed: Jan. 6, 2003

Related U.S. Application Data
(63) Continuation-in-part of application No. 09/982,696, filed on Oct. 17, 2001.

(51) Int. Cl. G06F 17/00

(52) U.S. Cl. 463/42

(57) ABSTRACT

The present invention provides a method and system for creating an Interactive Services Facility through which interactive services can be delivered. In one embodiment, the present invention also provides a method and system for repurposing a physical structure to enable the delivery of interactive services and, more specifically, to a method and system of creating a gaming environment within a repurposed movie theater structure. The modification of a facility in accordance with the present invention creates an Interactive Services Facility with an operational environment capable of delivering interactive services, such as gaming, to users. The operational environment is enabled by the present invention through novel systems and methods of modifying the infrastructure of a facility and providing novel operational systems for the delivery of interactive services.

### CROSS REFERENCE

The present invention is a continuation-in-part of U.S. patent application Ser. No. 09/982,696, entitled “Method and System for Providing an Environment for the Delivery of Interactive Gaming Services”, filed on Oct. 17, 2001.

### FIELD OF THE INVENTION

The present invention relates generally to a method and system for repurposing a physical structure to enable the delivery of interactive services and, more specifically, to a method and system of creating a gaming environment within a repurposed movie theater structure.

### BACKGROUND OF THE INVENTION

Gaming involves playing a software-based game on an electronic-based platform, either against a machine, competitively against another person, or competitively against a group of people. Currently, there are two primary gaming platforms: console based platforms and personal computer (PC) based platforms. Console based platforms include, but are not limited to, the following systems: the PLAYSTATION system from SONY, the NINTENDO64 and GAMECUBE systems from NINTENDO, the DREAMCAST system from SEGA, and the X-BOX system from MICROSOFT. Each of the console-based platforms is built on proprietary technology designs so that the games, which are typically developed by independent game vendors, can only be used on one of the platforms. The PC based platform consists of personal computers, and the gaming experience on this platform is largely driven by the quality of the personal computer and on the peripherals attached to the personal computer.

The gaming experience on both platforms, including gaming online, is becoming increasingly popular. Revenues associated with both personal computer based games and console based games are increasing. The increase in popularity is being driven, in part, by improving game design and improving web-based gaming sites, as well as by increasing personal computer speed. See, for example, “Untangling the Online Gaming Web,” New York Times, page G1, Jul. 5, 2001. Competitive gaming is also become increasingly popular. With respect to the online gaming experience, a number of web sites now provide access to gaming services. See, for example, gamespy.com, yahoo.com, zone.msn.com, station.sony.com, ea.com, sega.net, flipside.com and gamesdomain.com.

Existing Internet-based, distributed, on-line gaming services have several disadvantages, however. Because the gaming experience can be highly influenced by speed and reaction time, personal computer hardware and Internet access become critical elements in creating a positive gaming experience. Specifically, because users must provide their own software, hardware, and Internet connection, to achieve optimal experiences, they must invest in high quality modems to insure they can access the Internet at high bit rates and invest in high-grade Internet access to actually establish a high bit rate connection. Users must also perform diligence on their Internet Service Provider to insure they have sufficient gateway bandwidth to the Internet. Users who do not have high quality modems, high-grade Internet access, or quality Internet Service Providers (ISPs) often find themselves at the mercy of players with a better technology infrastructure. Players with a better infrastructure have their gaming activities, as recorded and communicated by their local computer, more rapidly recognized by the central server, enabling an improved reaction time and, as such, a substantial playing advantage. Further, even when the optimal hardware and access configuration is created, a gamer is still subject to the uncertainties associated with the transmission of information over the Internet. As such, gaming experiences associated with the Internet can be less than optimal.

Moreover, for users who play at home or at work, the gaming environment is not stimulating or integrated into an entertaining environment. Users are limited to engaging with a single computer monitor on a single personal computer and playing alone or in the presence of disinterested individuals. Conventional gaming environments fail to provide an exciting, engaging, or sporting atmosphere.

At least one organization has held gaming tournaments that physically bring together gamers to a single location to compete in conventional video games. Battletop, a Korean organization, has physically placed gamers in large empty spaces and provided them with personal computers placed atop conventional, fold-up tables and has interconnected them with server systems. Sitting on conventional, fold-up chairs, users access personal computers to conduct multi-user game scenarios and compete in gaming tournaments with other locally present users.

While positively addressing the need for users to have the proper hardware and software by providing the basic infrastructure for them, these conventional gaming tournaments suffer from several disadvantages. Because they require substantial space in order to safely and effectively provide a gaming environment, these conventional facilities cost a significant amount of money to initially open and operate. Additionally, because those interactive environments are stand-alone entities, they are not integrated into other services that could substantially improve the user experience. As such, they often fail to provide users anything other than basic access to software and hardware. Many users want an improved environment, including exciting visuals, automated access to food and beverages, and proximity to other interactive or entertainment oriented services.

Attempts at enabling gaming in an existing entertainment facility have been confined to the placement of video game terminals in movie lobbies or creation of temporary games, played in between movie showings, which fail to accommodate existing gaming platforms or allow for different games to be played by different users at the same time.

### SUMMARY OF THE INVENTION

It would be therefore preferable to have a method and system for repurposing existing facilities to create environments within which gaming services and other informational interactive services could be provided. It would also be preferable to have such a method and system maximally use the existing facilities to avoid creating redundant or under utilized infrastructure and to avoid the introduction of operational inefficiencies, thereby minimizing the capital expenditures required to open and/or operate such a facility. It would further be preferable to have a method and system for providing interactive services that is integrated with other services to improve the user experience and substantially remove the disadvantage that arises out of inconsistency between hardware, software and connection configurations of gamers as well as the uncertainty associated with the transmission of information over the Internet. It would also be preferable to have methods and systems that integrate existing gaming platforms into an entertainment facility and permit multiple users to play different games concurrently.

Accordingly, the present invention provides a method and system for creating an Interactive Services Facility through which interactive services can be delivered. The present invention also provides a method and system for repurposing a physical structure (referred to herein as a Facility or Facilities) to enable the delivery of interactive services and, more specifically, to a method and system of creating a gaming environment within a repurposed movie theater structure. The modification of a Facility in accordance with the present invention creates an Interactive Services Facility with an operational environment capable of delivering interactive services, such as gaming, to users. The operational environment is enabled by the present invention through novel systems and methods of modifying the infrastructure of a Facility and providing novel operational systems for the delivery of interactive services.

In one embodiment, a gaming station for providing at least one user access to a plurality of games comprises a top surface having a plurality of access ports, a plurality of side walls, connected to the top surface, having a plurality of access ports, and an internal compartment, defined by the top surface and at least one of the side walls, for containing at least two computers.

Optionally, the user can access at least one of the computers, which may be a console-based device, by entering through at least one of the access ports. The user may access the console based game device to load a game and may access it by sliding a door open or by pulling a door open. The access port may include a locking mechanism.

Optionally, the user can retrieve a controller through an access port in the top surface. In such cases, the controller may be a joystick, a mouse, or any other device.

Optionally, one of the computers is a console-based gaming device and a second of the computers is a control unit. The control unit can be a personal computer in data communication with a card reader. The card reader may be accessed through an access port. The control unit may be in data communication with a monitor and may operate by activating the monitor to display data received by the console based gaming device when the control unit is activated by the user. The control unit may be activated by insertion of a card into a card reader.

Optionally, the gaming station further includes a leg extension space under the top surface and proximate to at least one of the side walls. Additionally, the user can access a plurality of interfaces for at least one of the computers through at least one of the access ports, thereby allowing the user to physically connect devices to the interfaces. The top surface of the gaming station and the plurality of side walls can be comprised of any solid material, preferably metal. Further, it is preferred for the top surface and the plurality of side walls to have rounded edges. The top surface may be coated with an insulating material.

Optionally, the gaming station can include a cooling system in an internal compartment, an audio routing switch, or a monitor located on the top surface. The cooling system may comprise a plurality of spaces in the side walls.

In another embodiment, the present invention includes a method of modifying aisle space in a theater having stratified seating wherein a first row, having a plurality of fixed seats, is lower in elevation relative to a second row, having a plurality of fixed seats and wherein the first row and the second row are separated by a first aisle space. The method comprises the steps of removing the plurality of fixed seats from the first row, removing the plurality of fixed seats from the second row, installing a platform structure that increases the first row elevation, and inserting a plurality of interactive service stations in the first row and in the second row wherein the first row and the second row are separated by a second aisle space and wherein the second aisle space is greater than the first aisle space.

Optionally, the interactive service station may comprise a top surface having a plurality of access ports, a plurality of side walls, connected to the top surface, having a plurality of access ports, and an internal compartment, defined by the top surface and at least one of the walls, for containing a plurality of computers. Further optionally, the platform structure may have an access port through which areas under the platform can be accessed.

In another embodiment, the present invention includes a method of modifying aisle space in a theater wherein a first row, having a plurality of seats, is separated from a second row, having a plurality of seats, by a first aisle space. The method comprises the steps of removing the plurality of seats from the first row, removing the plurality of seats from the second row, and inserting a plurality of gaming stations in the first row and in the second row wherein the first row and the second row are separated by a second aisle space and wherein the second aisle space is greater than the first aisle space.

In another embodiment, a modified theater provides interactive services to a plurality of users and comprises a back wall, a front wall having a wide-area screen wherein said screen has a base area, two side areas, and a top area, a floor, a plurality of side walls in physical communication with the back wall and the front wall, a monitoring station proximate to the front wall, a plurality of gaming stations, each having at least one computer, dispersed throughout the theater, and an event area for the staging of interactive service events.

Optionally, the event area is elevated relative to the floor, is proximate to the back wall, is enclosed by a fence, or is proximate to the front wall. The event area can be a location where gaming competitions between a plurality of users are conducted in the event area.

In another embodiment, a facility delivers interactive services to a plurality of users by providing a plurality of gaming stations arranged in a plurality of rows, a floor having at least two different elevations wherein the floor operates as a foundation for each of the rows of gaming stations, and a front wall having a projection screen.

The present invention therefore provides a method and system for repurposing existing facilities to create environments within which gaming services and other entertainment or informational services could be provided and maximally uses the Facilities to avoid creating redundant or under utilized infrastructure and to avoid the introduction of operational inefficiencies. The present invention also provides a method and system for providing interactive services that is integrated with other services to improve the user experience, including reward and affinity programs. The present invention further provides a novel platform through which a user can access multiple gaming platforms and play different games, against a plurality of persons, within an entertaining environment.

### BRIEF DESCRIPTION OF THE DRAWINGS

These and other features and advantages of the present invention will be appreciated, as it becomes better understood by reference to the following Detailed Description when considered in connection with the accompanying drawings, wherein:

FIG. 1 is a floor plan of one embodiment of an Existing Facility;

FIG. 2 is a plan of one sectioned area within one embodiment of an Existing Facility;

FIGS. 3 & 3A are diagrams of different embodiments of a seating configuration for an Interactive Services Facility;

FIGS. 4 & 4A are side views of different embodiments of Interactive Gaming Stations;

FIG. 5 is a diagram of one embodiment of a network and the audio and visual delivery system within an Interactive Services Facility;

FIG. 5A is a diagram of one embodiment of a network between multiple Interactive Service Facilities;

FIG. 6 is a diagram of certain modified facilities within an Existing Facility;

FIG. 7 is a flowchart depicting the operation of one embodiment of an Interactive Services Facility ticketing system;

FIG. 8 is a flowchart depicting the operation of one embodiment of a first operational system within an Interactive Services Facility;

FIG. 9 is a flowchart depicting the operation of one embodiment of a second operational system within an Interactive Services Facility;

FIG. 10a is a diagram of one embodiment of a network management system for use in an Interactive Services Facility;

FIG. 10b is a depiction of an event interface for one embodiment of a first network management subsystem for use in an Interactive Services Facility;

FIG. 10c is a flowchart depicting the operation of one embodiment of a first network management subsystem for use in an Interactive Services Facility;

FIG. 10d is a diagram of one embodiment of a second network management subsystem for use in an Interactive Services Facility;

FIG. 10e is a diagram of one embodiment of a third network management subsystem for use in an Interactive Services Facility;

FIG. 11 is a block diagram depicting a plurality of areas in an Interactive Services Facility;

FIG. 12a is a top plan view depicting another embodiment of an Interactive Services Facility;

FIG. 12b is a top plan view depicting another embodiment of an Interactive Services Facility;

FIG. 12c is a top plan view depicting another embodiment of an Interactive Services Facility;

FIG. 13 is a side elevation view of a modified stadium-seating theater floor;

FIG. 14a is a side elevation view of consecutive aisles of a conventional stadium-seating theater floor;

FIG. 14b is a side elevation view of modified aisles using false flooring;

FIG. 15 is a top view of a pod showing a plurality of Interactive Gaming Stations, arranged for team play;

FIG. 16 is a functional block diagram of an Interactive Gaming Station;

FIG. 17 is a functional block diagram of a data network;

FIG. 18 is a block diagram depicting a control matrix of a data network;

FIG. 19 is a patch plan of a control matrix;

FIG. 20 is a first exemplary depiction of an Interactive Services Facility;

FIG. 21 is a second exemplary depiction of an Interactive Services Facility;

FIG. 22 is a third exemplary depiction of an Interactive Services Facility;

FIG. 23 is a fourth exemplary depiction of an Interactive Services Facility;

FIG. 24 is a fifth exemplary depiction of an Interactive Services Facility;

FIG. 25 is a sixth exemplary depiction of an Interactive Services Facility;

FIG. 26a is one view of a first embodiment of a gaming station;

FIG. 26b is a second view of a first embodiment of a gaming station;

FIG. 27a is one view of a second embodiment of a gaming station;

FIG. 27b is a second view of a second embodiment of a gaming station;

FIG. 27c is a third view of a second embodiment of a gaming station;

FIG. 28a is one view of a third embodiment of a gaming station;

FIG. 28b is a second view of a third embodiment of a gaming station; and

FIG. 28c is a third view of a third embodiment of a gaming station.

### DETAILED DESCRIPTION OF THE INVENTION

The present invention provides a method and system for creating environments for the delivery of gaming services and other interactive services. Interactive services include any service whereby a user reacts to a stimulus from a service and the service provides a new interface to the user based on the user's reaction. More specifically, the present invention provides a method and system for the repurposing of movie theater facilities to provide gaming environments, including competitive gaming environments.

A presently preferred embodiment of the present invention maximally leverages the historical investment made in existing structures, referred to herein as an Existing Facility or Existing Facilities. Existing Facilities are any structures capable of housing people for short or long terms. They are preferably proximate to population centers, and preferably already possess an infrastructure for the provision of audio and visual (AV) based entertainment services. They may be physically designed as a plurality of sectioned areas, with each area being a substantially enclosed space. Alternatively, they may be designed as a single enclosed area prior to the modifications that will be made in accordance with the present invention. While the preferred embodiments of the present invention shall be described in the context of an Existing Facility, one of ordinary skill in the art would appreciate that the present invention can be implemented within any type of facility, whether new or existing, that has, or can be designed or modified to have, the necessary characteristics described herein, referred to herein generally as a Facility or Facilities. Moreover, while the present invention can be implemented within any type of Facility, the preferred embodiments of the present invention shall be described in the context of movie theater facilities.

As discussed below, the modification or creation of at least one sectioned or partitioned area, created by at least one wall, within an Existing Facility, in accordance with the present invention, creates an Interactive Services Facility with an operational environment capable of delivering interactive services, such as gaming services, to users. The operational environment is enabled by the present invention through novel systems and methods of modifying the infrastructure an Existing Facility and providing novel operational systems for the delivery of interactive services. Each of said methods and systems are described in detail below.

The present invention is also directed to an Interactive Services Facility, whether or not originally developed from an Existing Facility. The Interactive Services Facility possesses a novel configuration for the provision of AV based entertainment services and provides an operational environment capable of delivering interactive services, such as gaming services, through novel operational systems for the delivery of interactive services.

A. Methods and Systems to Adapt the Infrastructure of an Existing Facility Such As a Movie Theater Complex to Create an Interactive Gaming Services Facility.

1. Interactive Services Facility

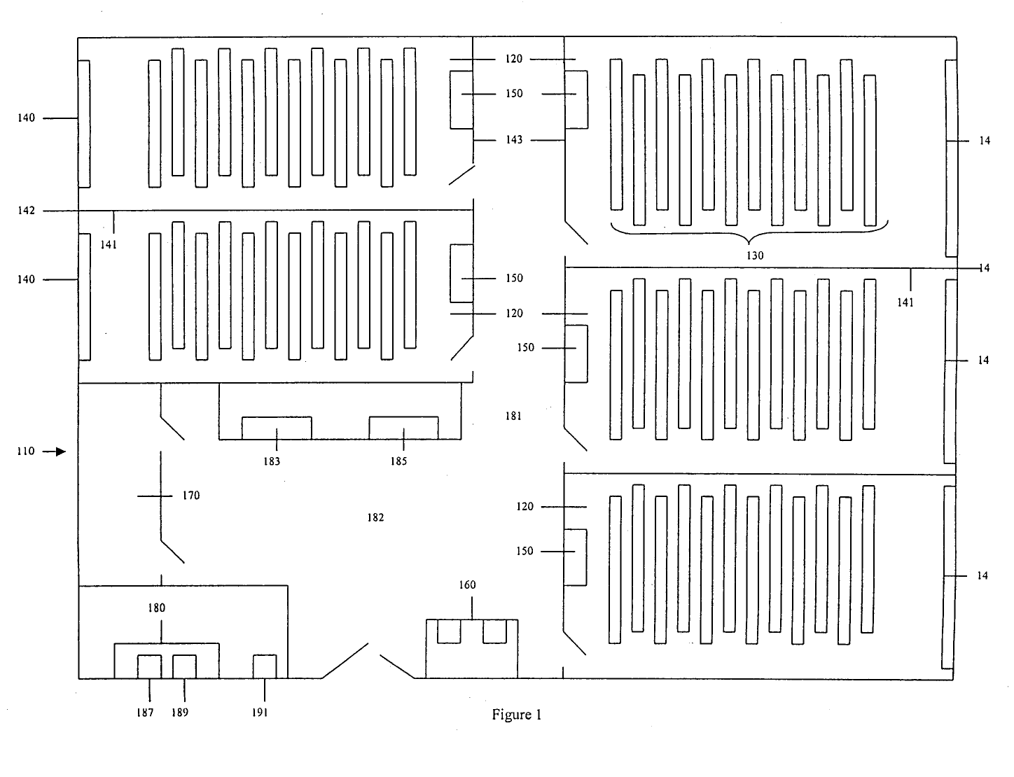

Referring to FIG. 1, a floor plan of a preferred Existing Facility, a movie theater complex 110, is shown. The movie theater complex 110 has a plurality of sectioned areas 120 for the delivery of AV entertainment. In the case of movie theaters, each sectioned area 120 would represent a separate and singular theater with its own seating configuration 130, screen 140, and AV delivery system 150. Within a single movie theater compound, there could any number of sectioned areas 120, preferably from 14 to 30 sectioned areas 120. The movie theater complex 110 preferably has a lobby 182, a common pathway 181 to the sectioned areas 120, a concession area 160 for dispensing food and beverages, a plurality of restrooms 170, and operational systems for conducting and managing the sale of tickets 180, food and beverages 183, and other goods 185, such as coupons and gift certificates.

In accordance with one embodiment of the invention, each sectioned, or partitioned, area 120 is preferably completely enclosed, substantially enclosed, or partitioned, from other sectioned areas by at least one wall or partition. At least one side wall 141 divides each sectioned area 120 from other sectioned areas 120 and from the common facilities 160, 170, 182. A front-wall 143 divides the sectioned area 120 from the common pathway 181 and lobby 182 and a back wall 142 separates the sectioned area 120 from the outside environment. Additionally, each sectioned area 120 has a ceiling [not shown] to separate it from the environment or other floors of the structure.

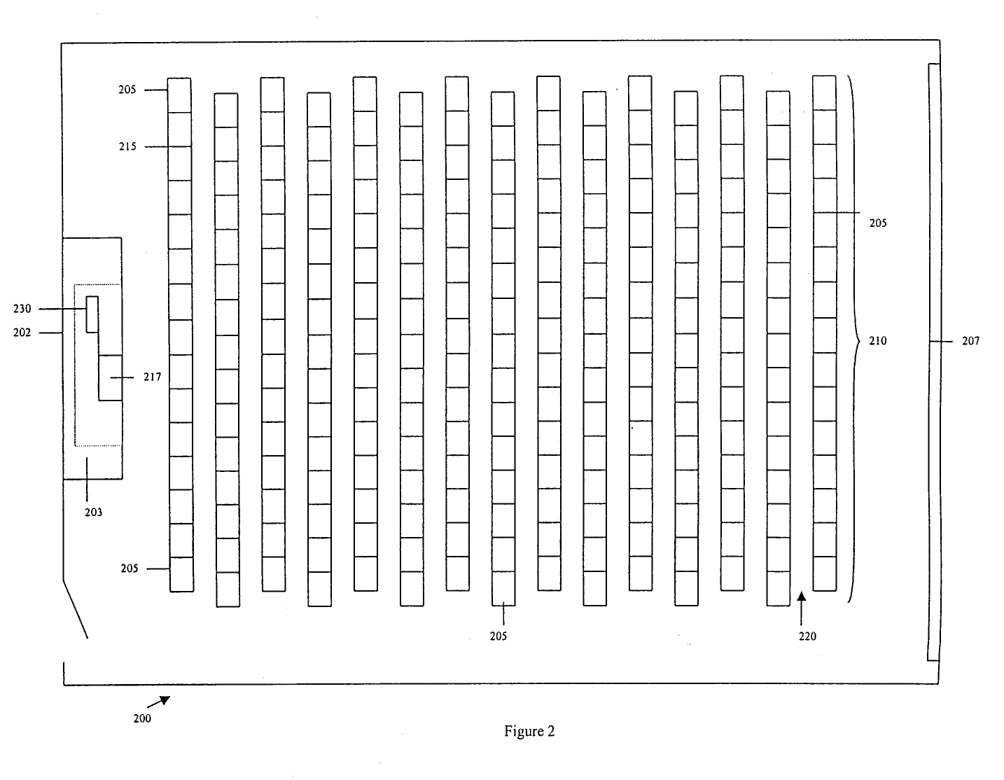

More specifically, as shown in FIG. 2, one of the sectioned areas 200 of a movie theater complex (not shown in its entirety in FIG. 2) comprises an AV delivery system 202 and a plurality of seats 205 in a row-by-row configuration facing a central screen 207. As shown, each row 210 has a plurality of seats 205 and each row 210 is preferably offset by one-half seat length relative to its preceding and succeeding row, creating an aisle having a width equal to one-half seat length. The seats 205 optionally have dividing armrests 215 that are either fixed or rotatable. The rows 210 are separated by a space 220 sufficient enough to permit both leg space for persons sitting in the preceding row 210 and traversing space to allow third parties to access seats interior to the row 210 from the exterior and vice-versa. The relative elevation of each row 210 can be equal or stratified, depending upon preference. In stratified or stadium seating, the elevation of each row 210 relative to the base floor of the sectioned area 200 increases for each row 210 as one moves away from the screen 207. One of ordinary skill in the art would appreciate that existing facilities use different values for the space 220, number of seats 205 per row, number of rows 210 per sectioned area 200 and relative elevation of rows to one another. In the case of a singular movie theater within a multiple theater movie compound, there may be fewer than 90 seats or more than 600, with 150 to 300 seats being typical. Also the quality and size of the seats 205 may differ and can be optionally changed depending on preference.

The wide-area screen, referred to as a screen, 207 and AV system 202 cooperatively work to deliver entertainment to persons sitting within the sectioned area 200. More specifically, the screen 207 receives images projected by a projector 217 located within a projection booth 203 conventionally located in the back of the sectioned area 200 and in a position elevated relative to the seating rows 210. The projector 217 is connected to an audio system 230 that delivers the audio that accompanies the projected images to a speaker system [not shown]. The speakers are preferably located throughout the ceiling and walls of the sectioned area 200 to deliver a full, holistic acoustic experience.

To enable the cost-effective creation of an Interactive Services Facility within the movie theater complex, and therefore the cost-effective delivery of interactive gaming services, the methods and systems used to modify one or more sectioned areas within the movie theater complex into one or more Interactive Services Facilities may use the existing infrastructure in the above-described sectioned area.

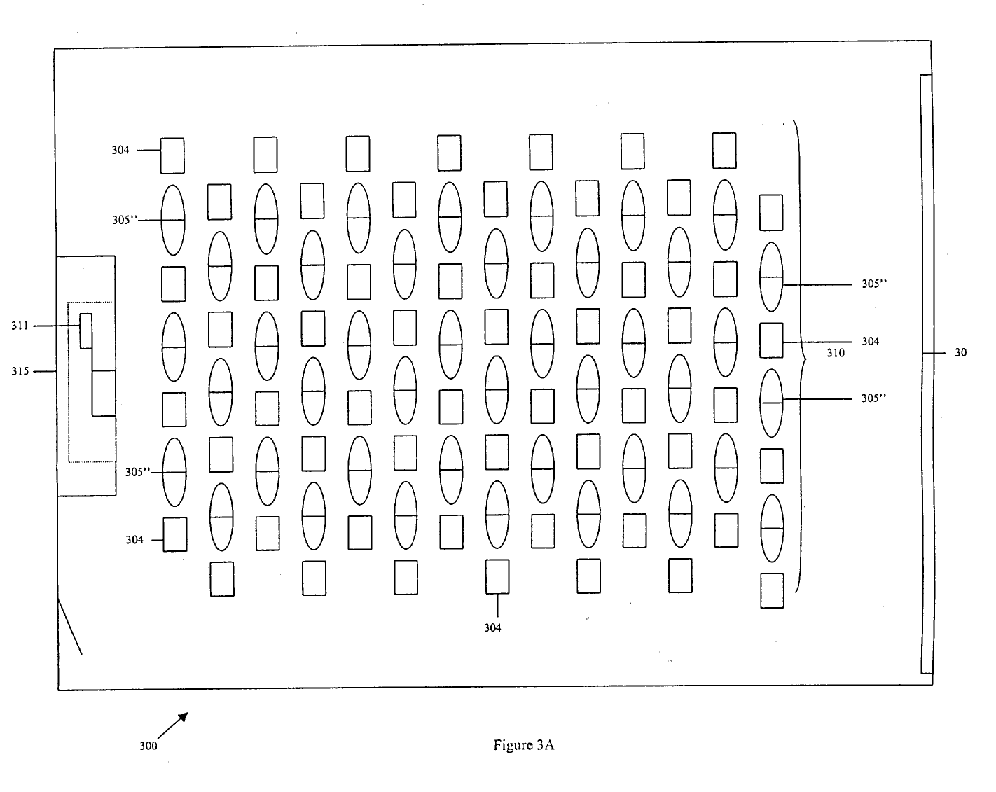

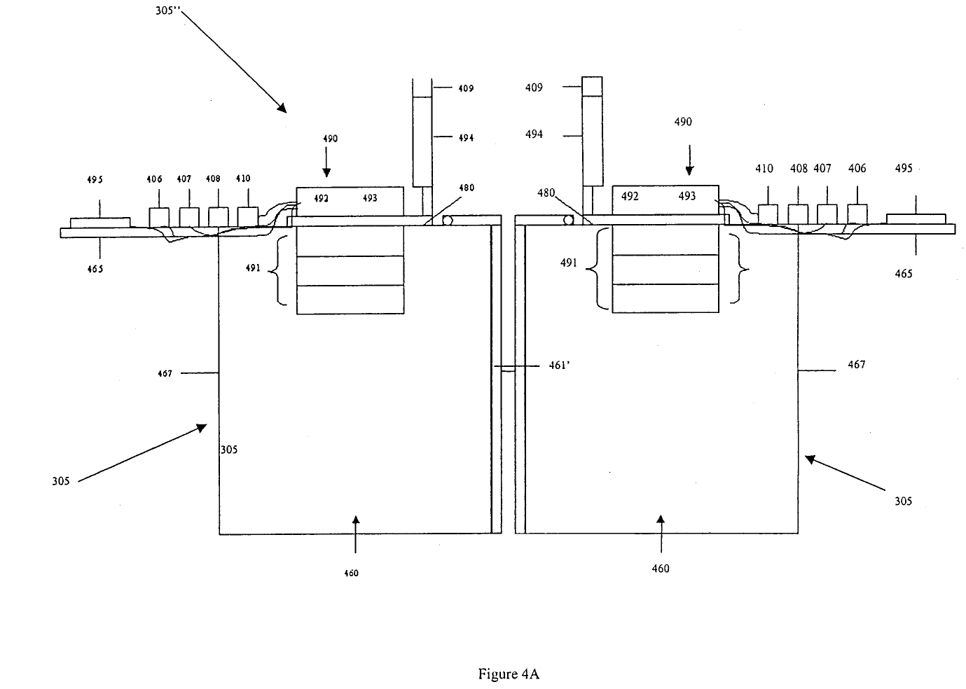

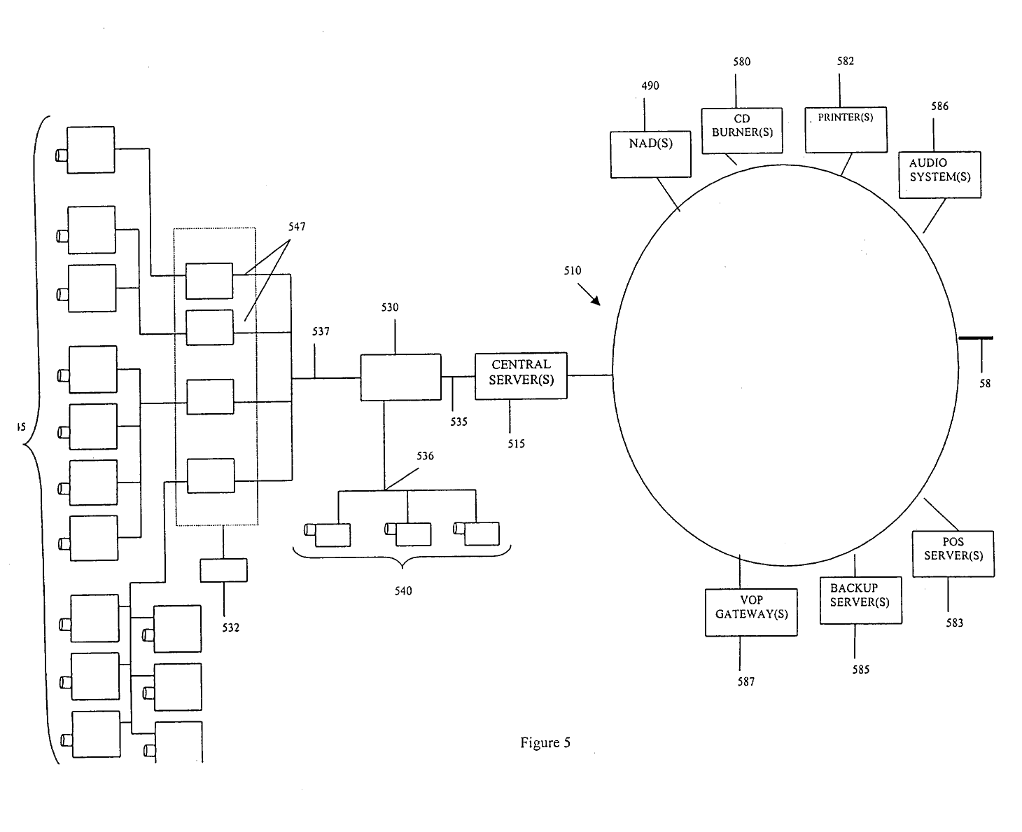

As shown in FIG. 3, the above-described sectioned area 200 can be adapted into the Interactive Services Facility 300 by (1) modifying the seating configuration to permit the insertion of Interactive Gaming Stations 305 capable of docking and housing a personal computer based or a console based game platform, (2) by providing seating 304 that allows each user to have unimpeded access to one of Interactive Gaming Stations 305 that preferably allows each user to flexibly view the screen 307 and that allows other users to move from the row 310 exterior to the row 310 interior and vice-versa, and (3) by providing a game enabled personal computer and/or one or more console game platforms. Other adaptations of the sectioned area 200 that are preferred include the introduction of a network 510, shown in FIG. 5, that interconnects the Interactive Gaming Stations 305 to a server 515 (network interconnections not shown) and the retrofitting of the AV system 315 to enable the projection of interactive gaming service activity on the screen 307 and through the speaker system 311.

FIG. 3 also represents an Interactive Services Facility that may have been originally built as an Interactive Services Facility and not a modified area of an Existing Facility. The Interactive Services Facility 300 has 1) Interactive Gaming Stations 305 capable of docking and housing a personal computer based or a console based game platform, 2) a seating configuration 304 that allows each user to have unimpeded access to one of Interactive Gaming Stations 305, preferably allows each user to flexibly view the screen 307, and allows other users to move from the row 310 exterior to the row 310 interior and vice-versa, 3) a network 510, shown in FIG. 5, that interconnects the Interactive Gaming Stations 305 to a server 515 (network interconnections not shown) and 4) an AV system 315 for the projection of interactive gaming service activity on the screen 307 and through the speaker system 311.

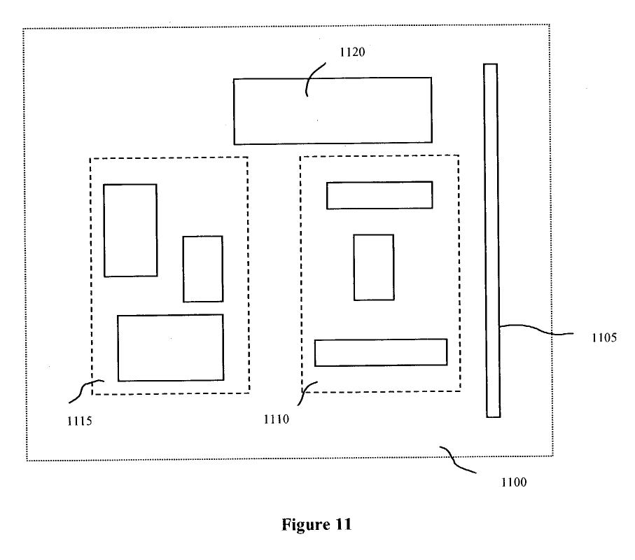

A preferred embodiment of the present invention utilizes the overall infrastructure of a movie theater complex while modifying an interior space, sectioned area, or partitioned area to create an exciting, comfortable gaming atmosphere. Referring to FIG. 11, a plurality of activity areas are preferably provided in an Interactive Services Facility (ISF) 1100. The ISF 1100 comprises at least one front projection screen 1105 for displaying gaming events, a plurality of playing floors 1110, adapted from the Existing Facility by suitable modifications, to house a plurality of Interactive Gaming Stations (IGSS) arranged in a variety of configurations to provide a gaming environment suitable for individual as well as team plays, areas for providing various community, announcement, hosting, entertainment or other services, hereinafter collectively referred to as community areas 1115, and at least one control area 1120 for managing and coordinating the operational environment of the ISF 1100.

One of ordinary skill in the art would appreciate that the facilities and the associated facility areas of the ISF 1100, can be laid out and further modified in a plurality of different ways depending upon, for example, the floor area available in the Existing Facility, the minimum and maximum number of gaming seats to be provided to achieve an appropriate financial return, the safety regulations required by national and/or local laws or any other operational and/or business related factors faced by persons of ordinary skill in the art. However, it is the intention of the inventors to create an operational ISF by designing an entertaining atmosphere that is practical to manage and optimally uses space.

As known to persons of ordinary skill in the art, a theater may have a seating configuration based upon a floor that, relative to the central screen, gently slopes upward, thereby raising each row in some elevation relative to the row before it, or have a stadium, or stratified, seating configuration based upon a floor and platform structure that substantially raises each row relative to the row before it. Both types of theater floors are adapted to support the plurality of activity areas as preferred in the ISF 1100. While, the stadium type theaters are modified by merging selective aisles already formed by the platform structure, as described in detail hereunder, the non-stadium regular type theaters may be modified by building a suitable platform structure on top of the sloping floor. One of ordinary skill in the art would appreciate how to modify a non-stadium seating theater in light of the present disclosure.

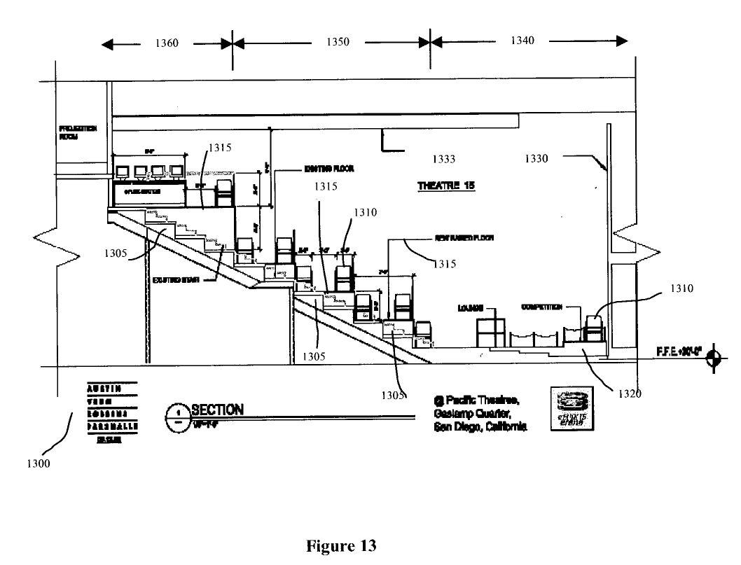

Referring now to FIG. 13, a stadium-seating type of theater floor has a plurality of structures 1305 that act as platforms for supporting seats. In a preferred method, at least two consecutive seating aisles, originally defined by rows of seats, are merged to create a gaming aisle 1315, defined by Interactive Gaming Stations 1310.

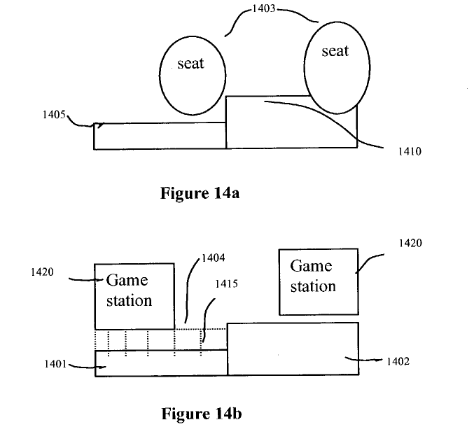

Preferably, a conventional theater is modified by first removing a few, some, or all of the seats, depending on the gaming environment desired. As shown in FIGS. 14a and 14b, the consecutive seating aisles 1405 and 1410 are merged to create a larger gaming aisle 1425. The seats 1403 are removed and a false floor 1415 is constructed on top of floor base 1401, such that the resulting floor 1404 becomes substantially equal to that of the adjacent floor base 1402, thereby, forming a single continuous aisle 1415. The false floor 1415 can be made of robust material and in any frame structure that is capable of supporting the weights of a plurality of Interactive Gaming Stations 1420 and players. Exemplary materials comprise hard plastic sheets, wood, metal, plywood or any other material known to persons of ordinary skill in the art. Once the continuous aisle 1415 is created, the Interactive Gaming Station 1420 (also referred to as a gaming station or station for games) can be inserted to maximize the aisle space 1415.

Alternatively the aisles 1405, 1410 could be merged by breaking off a part of the higher aisle 1410, so that it is at the same level as the lower aisle 1405. However, it is preferred that the desired merging be achieved by adding a false floor 1415 because of several accompanying benefits. For example, the false floor 1415 can act as a cover under which networking cables and other connection wirings, of the ISF, can be run; also, the false floor 1415 can be covered with tile carpeting that can be easily pulled up for accessing the underlying cabling. Most notably, the addition of a false floor avoids carrying out the heavy function of breaking a higher aisle to bring it down to the level of a lower aisle and the accompanying masonry work that may be required thereafter.

In yet another embodiment, all seating aisles can be merged to create a single level floor for the entire ISF. This could be achieved by adding false flooring that covers all the lower aisles to raise the level of the lower aisles to the level of the highest one, or by breaking down all aisles to the level of the lowest aisle, or by breaking part of the higher aisles and adding false flooring to the remaining lower aisles. One of ordinary skill in the art would appreciate the multiple combinations that may be implemented.

FIG. 13 shows a floor contour of an ISF 1300, which would be formed by adding false floorings. Selective floor bases 1305 are merged to form a plurality of gaming aisles 1315 that have been segregated into stages wherein each stage comprises at least one platform structure. In the arrangement of FIG. 13, the platform structures are grouped into three stages, 1340, 1350 and 1360. Stage 1340 comprises platform 1320, upon which, optionally, an Interactive Gaming Station 1310 is placed. Stage 1350 comprises three platform structures forming gaming aisles 1315. Stage 1360 comprises a single platform structure.

Referring to FIG. 11, the ISF 1100 can be conceptually designed as the plurality of stages 1340, 1350, 1360 shown in FIG. 13. Thus, in one arrangement, stage 1340 comprises at least one front screen 1105, at least one operation control area 1120, and at least one playing area 1110 having a plurality of gaming stations. In another arrangement, stages 1350 and 1360 are exclusively dedicated to gaming. In another arrangement, stage 1360 provides a plurality of gaming stations for solo playing and/or for team playing and further offers a gaming environment for competitive play in the form of an arena, ring, or other event-like platform.

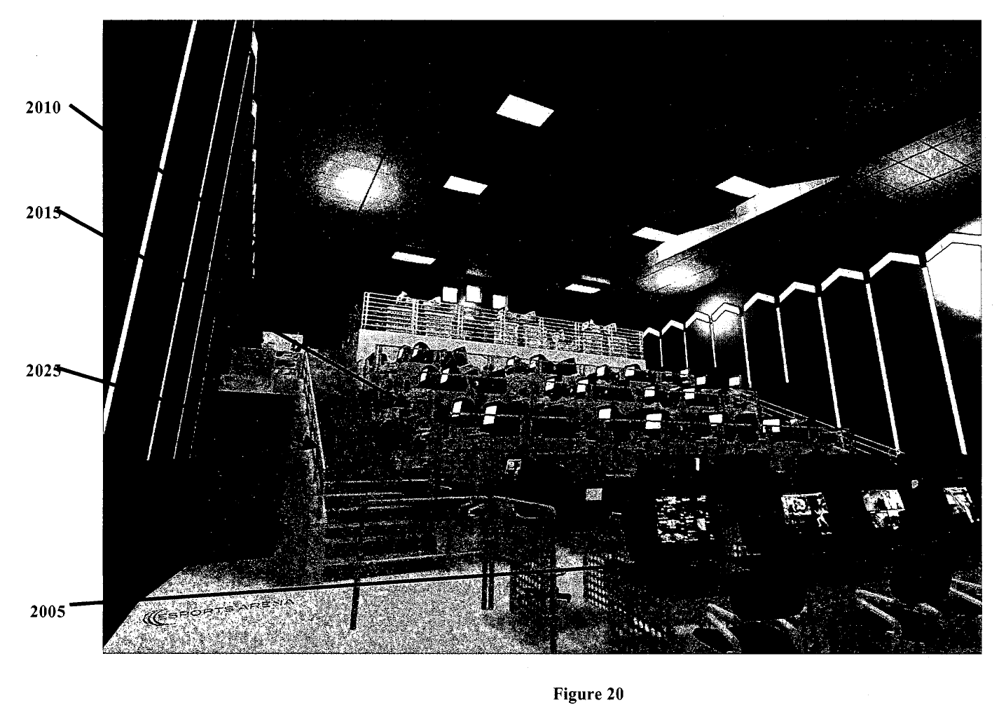

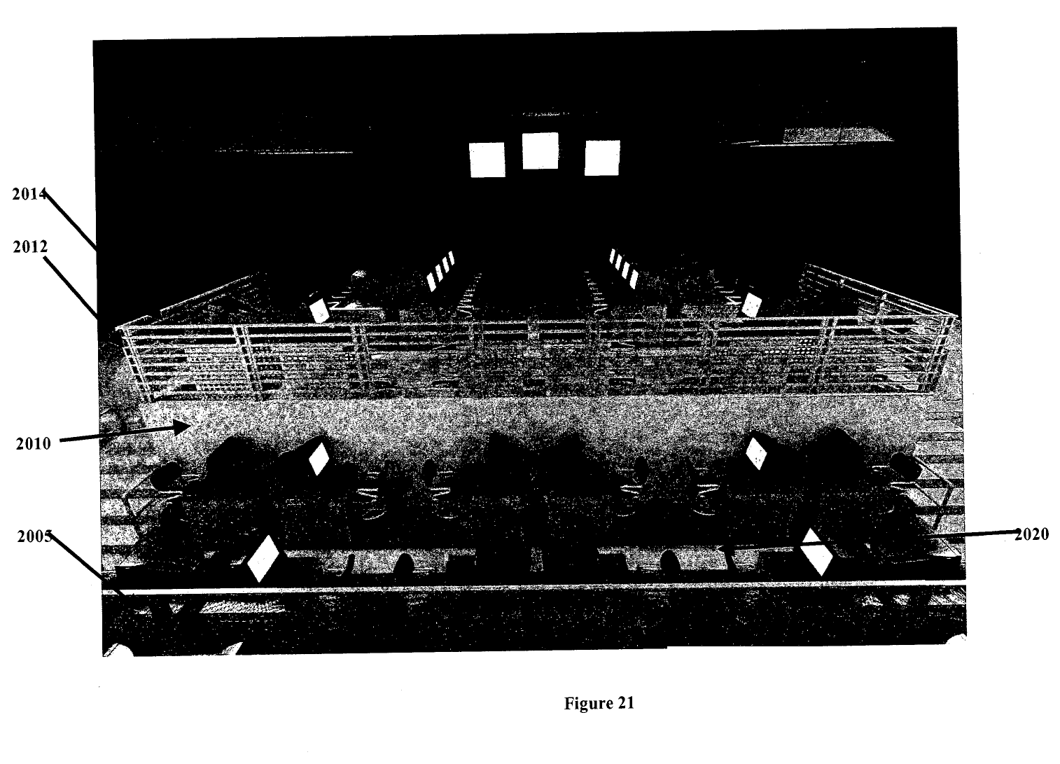

FIGS. 20 and 21 depict stages 1350 and 1360. A plurality of gaming stations 2005 is provided in relative elevation to one another. An arena 2010 having a plurality of wires or bars 2014 interconnected by posts 2012 defines an event area for competitive play. Separating rows of gaming stations 2005 are aisles 2020 formed by the aforementioned aisle formation methods atop platforms 2015. The number of platform structures included in each stage, the floor area allocated for each stage and the relative ambience created in each stage depends at least upon the nature and kinds of services/functionalities associated with each stage. The plurality of gaming stations and stages are accessible by staircases 2025.

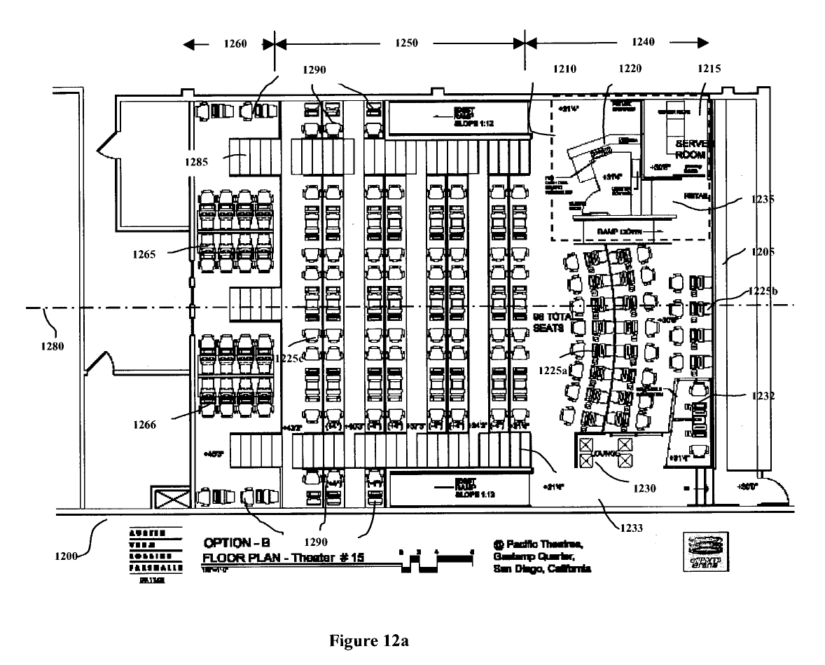

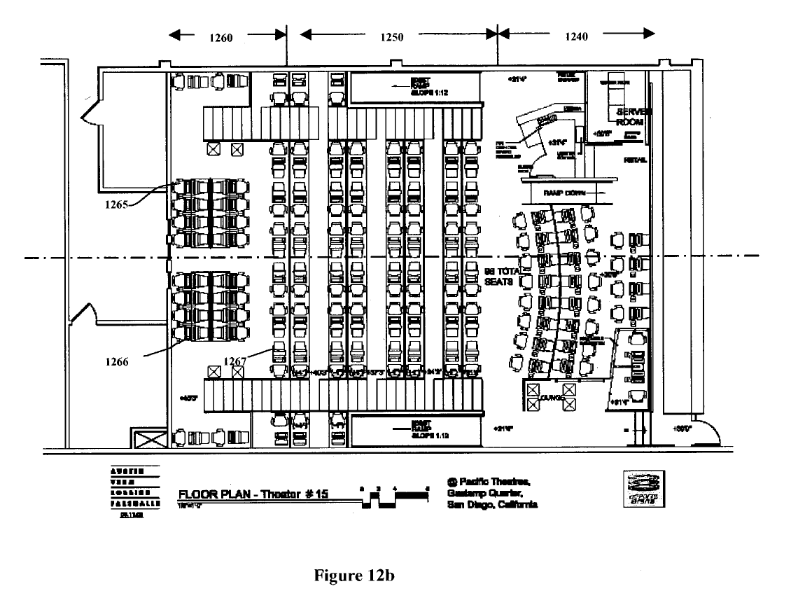

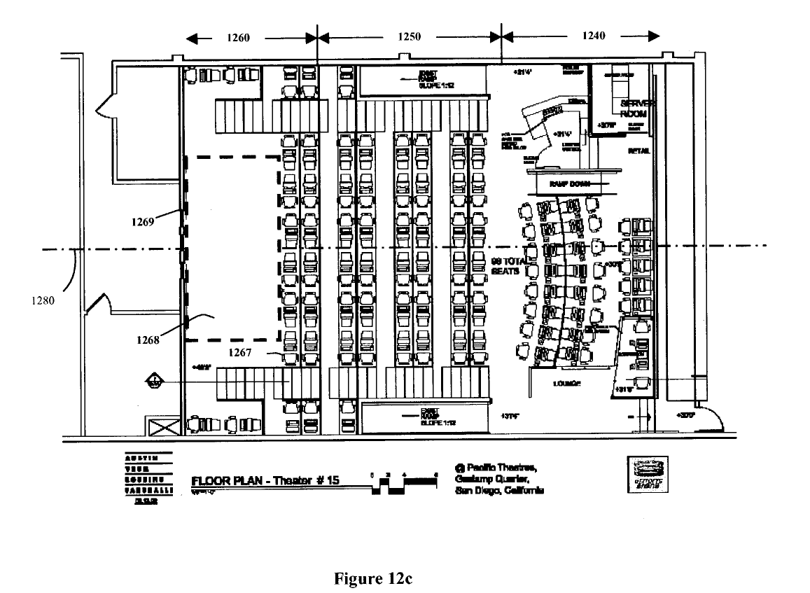

FIGS. 12a through 12c are top plan views, depicting a plurality of layouts of the ISF 1200, the floor contour of which has already been modified in accordance with FIGS. 13 and 14. In stage 1240, the front screen 1205 is a projection screen, preferably a movie theater projection screen retained as part of the existing infrastructure of the movie theater. Screen 1205 is suitably modified to include advertisings and reinforcements to protect against damage.

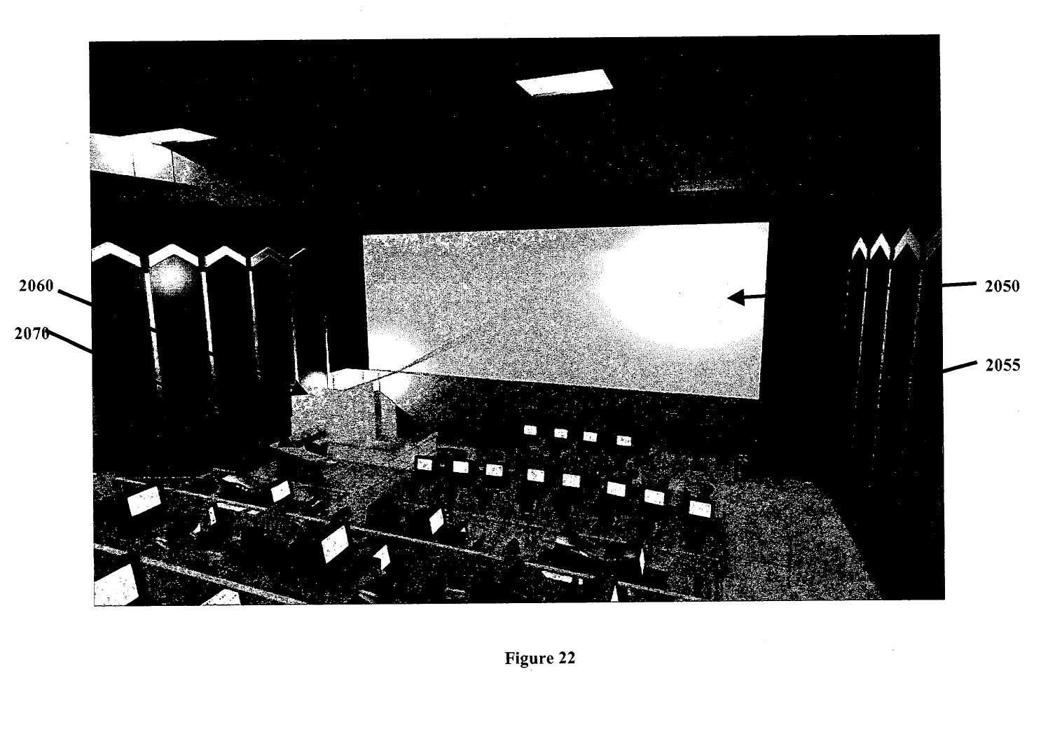

In one embodiment, shown in FIG. 12d the screen 1205 is elevated several feet off the ground and encompassed by a screen base 1210d that comprises a protecting material such as plastic, cardboard, plywood or metal or a combination of a protecting material and other items, such as translucent plastic, thin glass, or electronics, such as monitors and other displays. The bottom of the screen 1215d includes approximately 4-5 feet of screen material and is within reach of persons passing by the screen. By covering the bottom of the screen 1215d with a screen base 1210d, the screen material is protected from damage. In one embodiment, the screen base 1210d is positioned directly in front of the bottom of the screen 1215d. In another embodiment, the screen base 1210d is utilized to display advertisements made on materials such as cardboard, plywood and metal, thereby concurrently providing a form of protection and advertisement. In another embodiment, other coverings made of any type of material 1225d, 1220d, 1230d are incorporated onto the screen to provide a base for advertisements, displays, banners, or other communications. FIG. 22 depicts a screen 2050 having a screen base 2055 protected by a material covering, next to which is a server room 2060 and a control counter 2070.

Referring back to FIG. 12a, proximate to the screen 1205 is a control area 1210 comprising a server room, or computer room, 1215 and an operator control counter 1220. Adjacent to the control area 1210 is an area 1235 for the sale of items, also known as a retail area. The retail area 1235 can be used for selling gaming products such as game CDs, consoles and/or eateries such as snacks and soft drinks. The control counter 1220 is where gamers and/or subjects entering the ISF 1200 check-in, access the right to play games, and obtain desired games. Associated activities include taking photo identifications of users checking-in to the ISF and providing users with personalized smart cards for the identification and allotment of gaming stations. A single operator preferably manages the control area 1210; however, more people can be employed depending upon the amount of work and the rush during peak operation hours. In order to keep the number of operators minimal it is preferred that the control counter 1220 and the server room 1215 be next to each other so that, in case of any system malfunction, the operator at the control counter 1220 may have quick access to the server room 1215 to address the technical issue. If the server room 1215 is not placed proximate to the control counter 1220, more than one individual might have to be employed to provide services at the check-in counter 1220 as well as attend to the server room 1215 during a system problem.

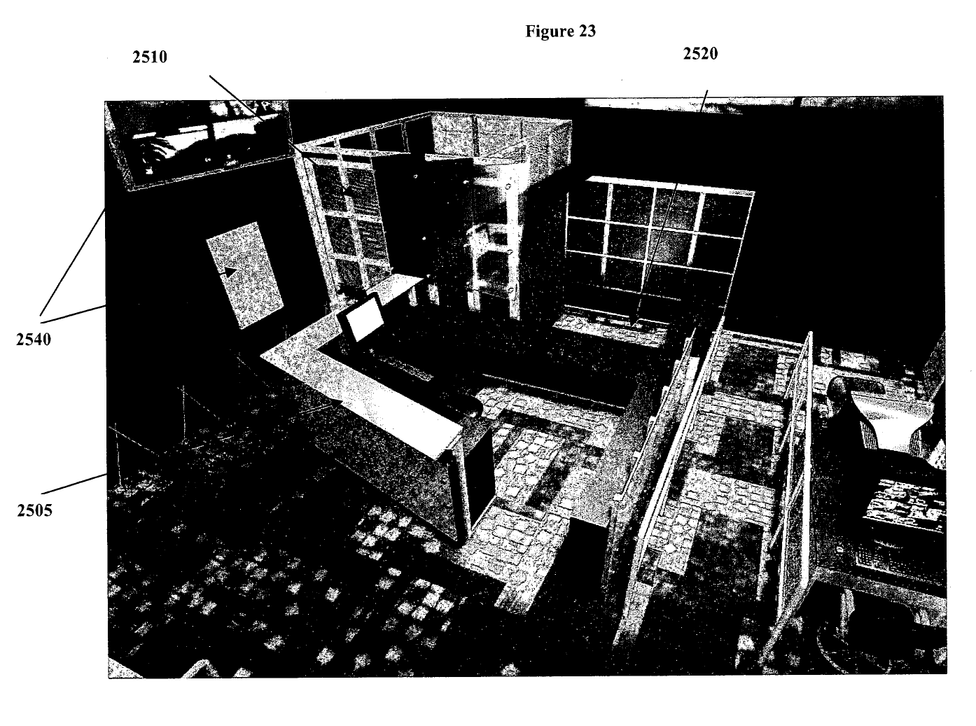

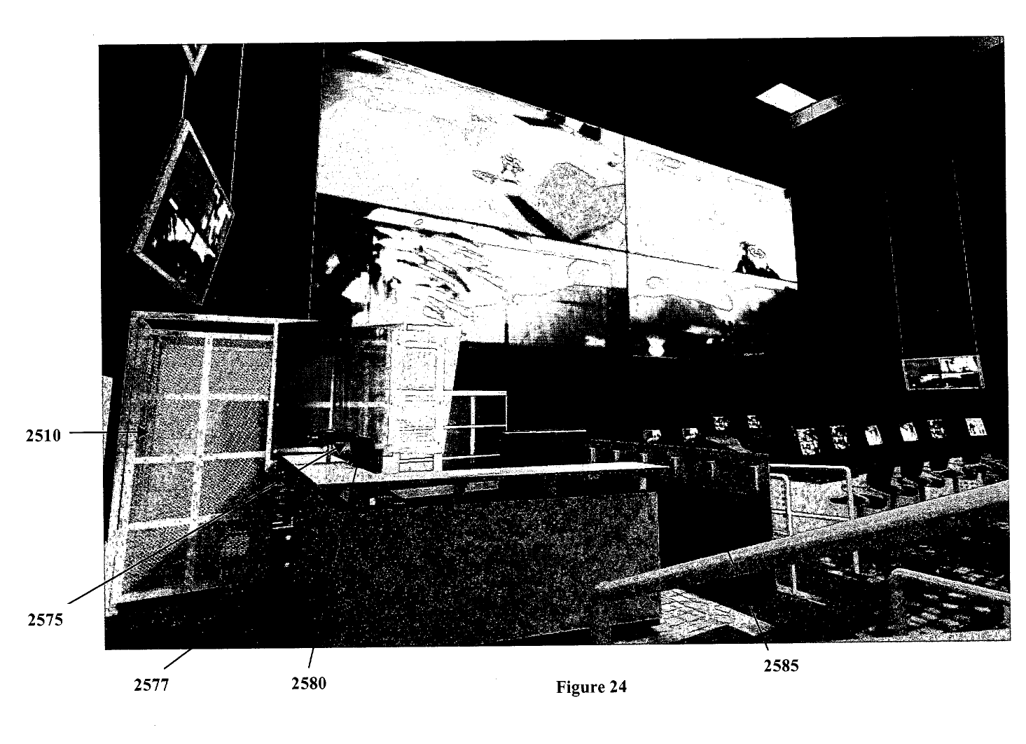

FIGS. 23 through 24 depict the control area with associated elements/structures. The control counter 2505 is adjacent to the server room 2510 and an area 2520 for the sale of items. Decorative items 2540, including screens, displays, graphic monitors, and other electronics may be further provided. The control counter 2505 further includes a camera 2575 for taking photos and/or videos of users, a desk 2577, a monitor 2580 attached to a computer [not shown], and a divider 2585 for crowd control.

Referring back to FIG. 12a, a portion of the floor area of stage 1240 is utilized for retrofitting a plurality of gaming stations 1225. Two rows of eight gaming stations 1225a are provided with their monitors back-to-back. Another row of four gaming stations 1225b are laid out next to the screen 1205. In one embodiment the gaming stations 1225b are used as children stations. The stations 1225b are close enough to the screen 1205 to allow for the shielding of children from projections of material not suitable for children. This enables children to participate in gaming activities concurrent with more mature users.

The floor area 1240 is not only utilized for providing the basic infrastructure and operational environment for hosting interactive services, such as gaming, but is also preferably enabled to provide an exciting and competitive milieu that integrates additional community services for improved user association and experience. Thus, in a preferred arrangement, community services are also offered by allocating floor area for a lounge 1230, a kid or parent's section 1233, and a competitive arena 1232.

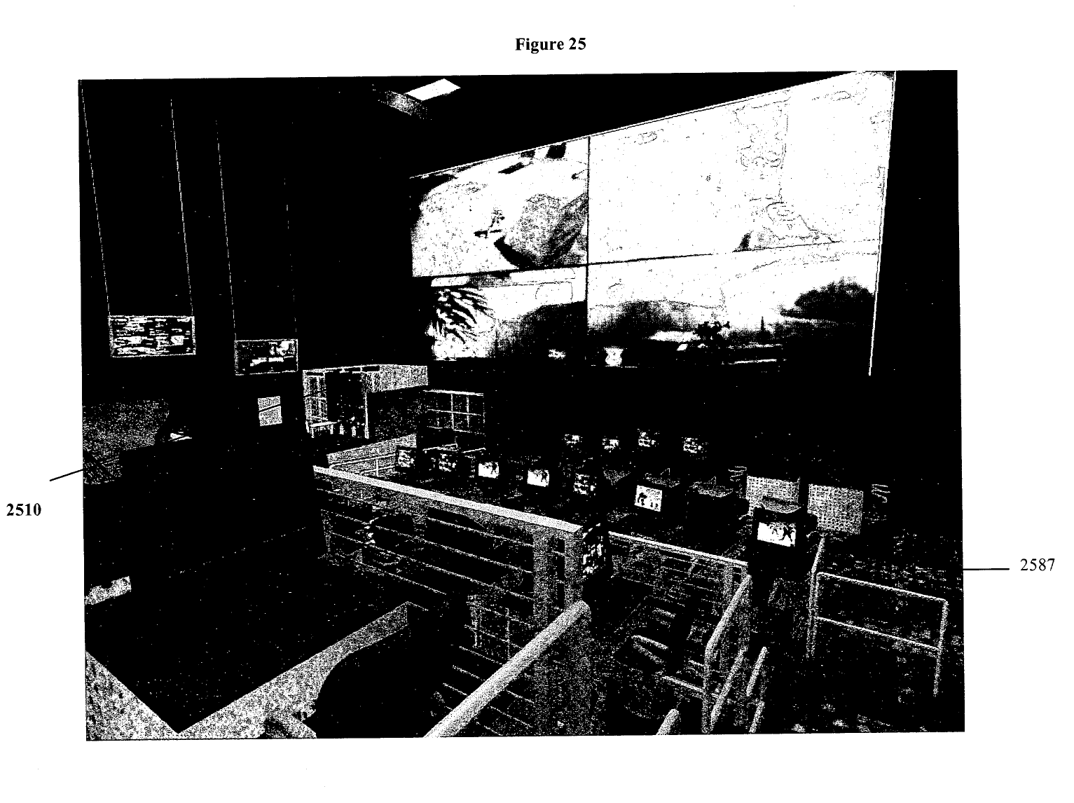

The kids' section 1233 is where parents can leave their kids and go to, for example, a movie, or the section 1233 can act as a parent's area, in conjunction with lounge 1230, from where parents can watch children play games. Alternatively, the lounge area 1230 is where any user can relax and watch games being shown on the at least one projection screen. The lounge area 1230 can also be partially or fully converted to a ‘ring’, in conjunction with area 1232, by inserting poles (connected by high tension wires) into holes on the sides of the lounge area 1230. The lounge area 1230 and the kid's section 1233 are preferably laid out in close proximity to each other so that in case the parents are relaxing in the lounge 1230 their kids can play and/or be taken care of by a babysitter in the kid's section 1233 and, in case of any urgency, the parents who are present in the lounge 1230 can quickly attend to their kids. FIG. 25 depicts a floor area 2587 where a lounge and kids' or parent's section can be supported, along with gaming stations that can be made the center of attraction on special events, such as during play between two top-ranked players.

Operationally, guardians could check their kids in to the control area 1210, receive an electronic buzzer alarm device, such as a conventional pager-client apparatus, and leave to go to different sectioned areas in the existing facility to engage in a separate activities, such as watching movies. The buzzer acts as a proximity tracker for the guardians so that an operator or babysitter can contact the guardian or send a message in case of any problem and prompt the guardian to return to the ISF.

It is preferred to use the buzzer for an intelligent system of messaging that can not only alert the guardian but also convey meaningful indications to the guardian as to the nature of the alert. Thus, in one embodiment, the buzzer delivers one of an auditory beep, vibration, or visual indicator, such as a light, to signal the guardian the nature of the message. For example, if the light signaling system, comprising a plurality of conventional LEDs (light emitting diodes), tiny electric bulbs, or any other system known in the art, flashes green it is an indication that the time allotted for the kid playing games in the facility is over. If it flashes red, it may indicate that the kid is misbehaving and therefore the guardians' discretion is required. Similarly, if it flashes yellow, it may suggest that the kid is looking for the guardian. One of ordinary skill in the art should however appreciate that other forms of messaging can additionally or alternatively be employed such as sending short text messages on the beeper system, or sending messages on the mobile phones of the guardians.

It should be evident to persons of ordinary skill in the art that in alternate embodiments the floor areas allocated to the community services could be reduced to either allow for more space to install additional IGSs or for allowing the introduction of additional community services while keeping the space, allocated for interactive services, same. To facilitate this kind of flexibility, it is preferred that the structures or infrastructure installed within the ISF, including the server room 1215, operator's counter 120, lounge area 1230 and the kids' section 1233, be modular so that if required the configuration, placement and/or size of these structures could be quickly modified as required. For example, the server room 1215 is a typical hard plastic or wooden walled structure that can be disbanded and shifted to a different area, that can be easily reduced in size, by adjusting its walls, to allow for more area to the adjacent retail outlet 1235, and that can similarly be extended in size to house more server computers and related equipment/accessories.

Stages 1250 and 1260 are maximally dedicated to supporting interactive services and comprise a plurality of rows, each row further comprising a plurality of Interactive Gaming Stations 1225. In one embodiment, shown in FIG. 12a, stage 1250 comprises eight rows of six gaming stations each. The gaming stations 1225c are preferably installed monitor-to-monitor so that two players playing against each other can sit opposite to and facing each other. This creates exciting and intuitive seating that reflects a sense of competition among the two players who can also easily talk and converse with each other without disturbing others.

Referring back to FIG. 13, the sectional elevation view shows that the platform structures, supporting the plurality of rows of gaming stations, form a terraced contour. The terraced contour of platforms is preferred since this arrangement allows the creation of differential levels of competitiveness within the interactive services facility, allowing for the association of each platform to differential services and that can be utilized to foster a highly exciting and charged atmosphere of gaming. For example, each platform level can be associated with the level of competency and/or ranking of the players so that players having a higher ranking have a preferential access to gaming stations on the higher-level platforms. Thus, while lower platforms could be for novice players, medium to higher platforms could be for medium to expert level players.

Similarly, differential services can also be a target of attraction at different levels. For example, players at higher-level platforms could be offered higher discounts on the community services, such as discount coupons for snacks and beverages at the retail outlet, available in the interactive services facility in comparison to the players at the lower level platforms. The higher-level platforms could be associated with more lucrative promotional and concession schemes in comparison to the lower level platforms. Additionally, paid coaching services could be made available for the players, such that the higher level players can not only avail of the coaching at a discount but they can also qualify as coaches for the lower level players and thereby earn in cash or in terms of more concessions and sops on the services available in the interactive services facility 1300.

Referring back to FIGS. 12a through 12c, stage 1260 is differentiated from stages 1240 and 1250 in that it is specifically enabled to act as a venue for hosting team games comprising more than two players. In an exemplary arrangement of FIG. 12a, stage 1260 comprises two pods, 1265 and 1266, of eight players each. Each pod has four stations playing next to each other and the four stations are placed monitor-to-monitor with a competing set of four stations. FIG. 15 is a top view of a pod 1500 showing, in a preferred arrangement, a set of eight gaming stations 1505 comprising chairs and monitors. A gap is allowed between the two teams so that a large projection screen can be placed therein for games that warrant a large projection of the gaming activity. Alternatively, the monitors can be swiveled back or down to allow sufficient space for a projection screen. Preferably, the projection screen is not a permanent installation, and, instead, such a screen is brought down from the ceiling 1333 when required and can be retracted back into the ceiling 1333 when not in use. Two projectors (not shown) are also positioned to project the game onto opposite sides of the screen.

It should be evident to persons of ordinary skill in the art that the number of pods, the number of players in a team in each pod and the configuration placement of the gaming stations therein can be modified depending upon the total floor area available on the corresponding stage and/or other factors such as the demand or popularity for games involving large teams. Thus while in one embodiment, of FIG. 12a, stage 1260 is shown comprising of only pods 1265, in alternate embodiments, of FIGS. 12b and 12c, an additional row of six stations 1267 is also placed. However, just like all the gaming stations in the interactive services facility 1200, the row of gaming stations 1267 can also be removed when required in order to make more room for team play, when having a major event and/or when focusing on a team game play. The pods 1265 can further be placed in different positions depending upon the situation.

As can be observed from FIG. 15, a typical pod 1500 is rectangular in shape having one side 1515 parallel to the chairs and one side perpendicular to the chairs 1520. Thus, while in FIG. 12a, the pods 1265, 1266 are placed with side 1515 parallel to the horizontal axis 1280, in the embodiment of FIG. 12b, the pods 1265, 1266 are placed with side 1520 parallel to the horizontal axis 1280. In FIG. 12c, the pods and gaming stations have been removed to leave an empty arena 1268 having fencing 1269 to delineate the boundaries of the arena 1268.

Users can access the gaming stations using a plurality of staircases 1285 that are typically part of the infrastructure retained from the existing facility. Also, in order to optimally utilize the floor area in the various stages, additional gaming stations 1290 are installed at available pockets or spaces along the walls of the interactive services facility 1200.

It is an intention of the inventors to not only provide an exciting environment within an interactive services facility but also maximally utilize it for commercial benefits. Thus, advertisements are placed at different locations, such as around the front projection screen, around the sides of the platform structures at various stages, as banners on the walls, as banners hanging off the ceiling or atop gaming station monitors. These advertisements could be made on any material, like cardboard, plywood, cloth/canvas, paper, cellulose, etc. Plasma screens may also be provided on the side walls of the interactive services facility. These plasma screens are not only used for displaying gaming and/or other interactive activities of the users but are also alternately used for displaying videos and/or images of advertisements/commercials for digital branding. Similarly, the audio systems within and/or outside the interactive services facility are used for airing advertisements, announcements and other related information.

2. Interactive Gaming Stations (IGSs)

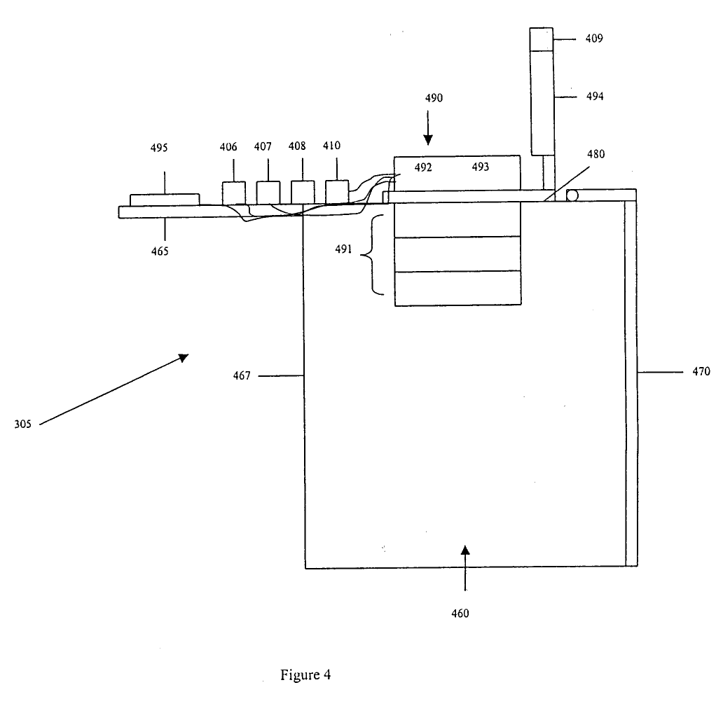

In accordance with a preferred embodiment of the present invention, the seating configuration of a sectioned area 300 is modified to allow for the insertion of Interactive Gaming Stations 305. As shown in FIG. 4, each Interactive Gaming Station 305 preferably comprises a seat encasing structure 460, a cabling path 470 for receiving and guiding electrical and network cabling, and a docketing platform 480 within which a computer or other network access device, hereinafter referred to as a network access device, 490 is placed. The seat encasing structure 460 is optimally designed to fit over the presently existing seats [not shown] in the sectioned area and be sufficiently sturdy to provide a solid surface upon which the network access device 490 is placed. Preferably the seat encasing structure 460 has a height that, when a network access device 490 is placed on top, permits an average sized user to comfortably interface with the network access device 490 through, for example, a mouse or keyboard. Further, it is preferred that the seat encasing structure 460 have a shape that comfortably accommodates the legs of an average-sized user. For example, a preferred seat encasing structure 460 has a lip 465 that extends forward and beyond the vertical baseboard 467 facing the user's legs. One of ordinary skill in the art would appreciate that the seat encasing structure is designed to cover a seat, without having to substantially modify it, and to provide a steady surface for the placement of a network access device, while still providing comfort and convenience to the user.

The network access device 490 can be any type of computer, comprising a memory 492, processor 493, monitor 494, and input device 495, such as a joystick, keyboard and/or mouse, capable of accessing a network, activating and operating applications off that network, and permitting users to input information into those applications. In a preferred embodiment, where the interactive service being provided is a gaming environment, it is further preferred that the network access device 490 have fast communication capabilities and high quality sound, video, and graphics cards. Wires extending into and out of the network access device are bundled and passed through the cabling path 470. The docketing platform 480 is preferably an attachment apparatus capable of holding the network access device 490 in place and preventing the network access device 490 from falling or from being stolen. The docketing platform 480 can be bolted to the seat encasing structure 460 and have a locking mechanism, such as a steel cable and key lock, to attach to the network access device.

The network access device may optionally also have a series of ancillary devices for the delivery of additional services to gamers. Ancillary devices can include a web camera 409, card swipe device 408, headset 407 (including microphone and speakers), and fingerprint reader 406. Connected to the processor 493 and memory 492, the web camera 409 can capture images of gamers and provide them to the network access device 490 for transmission through the local network, local use by the gamer, or transmission through the Internet to a pre-designated account. The card swipe device 408, also connected to the processor 493 and memory 492, may be used to track, in conjunction with a smart card, as will be further described below, gamer account information, including money spent, money available for spending, time played, and demographic information. Gamers can use the headset 407 to access specific sound channels and enjoy voice communications with other gamers or with others, without disruption or distraction from surrounding activities and the fingerprint reader 406 to identify them to the local system. It is contemplated that both the headset 407 and fingerprint reader 406 are connected to the processor 493 and memory 492. Additionally, one or more docking stations or read/write devices (e.g. disk drive, CD-ROM/CDR-W) 491 may be provided on the Interactive Gaming Station and operatively connected to the processor 493 and memory 492 to allow users to access, upload, synchronize and/or store data from a disk, CD-ROM, personal digital assistant (PDA), cellular telephone, pager and/or other similar mobile access or storage devices.

Although depicted as a conventional personal computer, the network access device could additionally or alternatively comprise one or more console gaming devices 497. Console gaming devices, such as those produced by SONY, NINTENDO, SEGA and MICROSOFT, are designed primarily for the playing of games and not as general use computers. They comprise a console game player for receiving a game cartridge or for accessing a network having a game capable of being played by the console game player and control implements for interfacing with the console game player. Console gaming devices typically interface with an existing monitor or television device to view gaming activity being enabled by the console game player. Also, the console gaming devices can be provided on the seat encasing structure 460 simultaneously with a personal computer.

Referring back to FIG. 3, a single seat encasing structure 460 is placed over alternating seats within a single row 310 such that the monitor 494 is viewed by a gamer in a line of sight that is essentially parallel with the single row 310. Atop each structure is the docketing platform, cabling path, and network access device, creating, in combination, an interactive gaming service station 305. Uncovered seats 304 adjacent to each newly placed interactive service station 305 are modified to enable the seat 304 to swivel, from a position that places the user directly facing the interactive gaming service station 305 to a position that places the user directly facing the screen 307. By allowing the seats 304 to swivel, users can be assured direct, unimpeded access to the interactive services station 305 and concurrently have the flexibility to view images projected on the central large screen 307. Optionally, alternate rows 310 can be removed to provide additional space between rows, thereby providing users with additional room to move from row exterior to row interior and vice-versa.

When installing the seat encasing structures 460, it is preferred that each structure have a portion of the structure base cut to accommodate the physical contours of the seat over which the structure is to be placed. As such, the specific design of the seat encasing structure 460 is dependent upon the seat in use in the movie theater complex. Upon installation, the seat encasing structure 460 would then slide over the seat and be attached either to the floor, to the seat, or to both in combination. The attachment mechanism can include any conventionally known means, including bolting, nailing, or screwing or, in the case of attachment to the seat, strapping the encasing structure to the seat itself. In the case of retractable seats or seats that cannot be readily accommodated, the seat may be removed and the seat encasing structure 460 may be directly attached to the floor. The attachment mechanism can include any conventionally known means, including bolting, nailing, or screwing the structure to the floor. Further, it is preferred to utilize the existing seat bolting structure to secure the seat encasing structure 460 as well as the seat, whenever possible.

In a presently preferred embodiment of the Interactive Service Facility, one or more mobile Interactive Gaming Stations 305′ may be provided within the sectioned area to allow users to design their own seating configuration. The ability for users to dynamically configure the arrangement of Interactive Gaming Stations may be desirable in connection with certain interactive games, for example, interactive games that require team play where it is necessary to protect the screen, movements or comments of one team from being observed by other teams. Referring again to FIG. 3, mobile Interactive Gaming Stations 305′ are provided and stored near the front of the sectioned area. Mobile Interactive Gaming Stations 305′ are substantially identical to Interactive Gaming Stations 305, except that they have not been attached to the floor of the sectioned area or to any of the seats within the sectioned area. Instead, mobile Interactive Gaming Stations 305′ include wheels or other similar means at the base of the encasing structure 460 that allows the Interactive Gaming Station 305′ to be easily moved within and throughout the sectioned area.

In the case of interactive gaming services, it may also be preferable to reconfigure existing rows in the back of the sectioned area to create an audience space 350 where individuals who are not currently accessing an interactive service station may watch activities on the large screen or access other services through kiosks, as illustrated in FIG. 3. It is also preferably to provide a disc jockey (DJ) area 352 where a DJ can create a sound experience for gamers or can provide alternate commentary on the activities occurring within the space 300. Where the DJ area 352 is provided, a connection into the network 510 and to the speaker system 311 is preferably provided. Connections to individual gaming stations can also be provided via the network 510.

While the seat encasing structure 460 is the presently preferred embodiment used to modify a movie theater complex to create an Interactive Service Facility with Interactive Gaming Stations, one of ordinary skill in the art would realize to other embodiments may additionally or alternatively be utilized. For example, referring to FIG. 4A, an alternative embodiment of an Interactive Gaming Station 305″ that is designed to provide two distinct gaming stations is illustrated. The Interactive Gaming Station 305″ is integrally designed to provide the essentially the same functionality as two Interactive Gaming Stations 305 juxtaposed so that they share a common wall 461′. The Interactive Gaming Station 305″ includes two sets of each of the gaming and network components provided for in the Interactive Gaming Station 305, organized in such a manner that two distinct gaming stations are provided. One of ordinary skill in the art would appreciate that the seat encasing structure 460′ of the Interactive Gaming Station illustrated in comprised is optimally designed to fit over two or more presently existing seats in the sectioned area. Referring now FIG. 3A, a single seat encasing structure 460′ is placed over two or more adjacent seats within a single row 310′. Uncovered seats 304′ adjacent and, on each side of the seat encasing structure 460′ are modified as described above. Alternatively, it may be preferable to initially remove the presently existing seats in the sectioned area before installing the Interactive Gaming Stations 305 or 305″. In such an embodiment, specially designed seats may be installed adjacent to each Interactive Gaming Station for the gamers to use. Such seats will preferably swivel or rotate so that gamers can easily rotate between their Interactive Gaming Station and the front screen of the sectioned area.

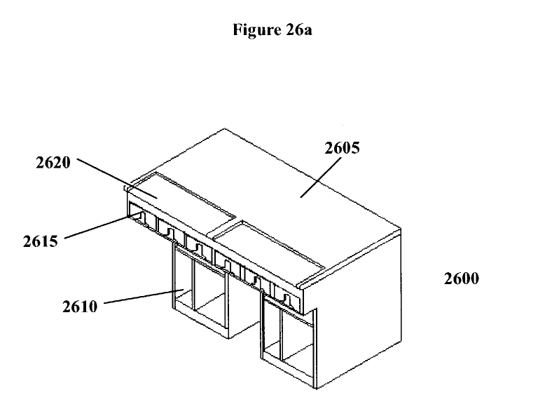

In one embodiment, shown in FIG. 26a, the gaming station 2600 comprises a top surface 2605 and a plurality of compartments 2615, 2610. The station is preferably metallic or made of metallic looking material with rounded edges and, if made of metallic, a top surface coating to thermally insulate users from excessively cold surfaces. The compartments 2610 are used to store gaming devices, such as console players or personal computers. Compartments 2615 are used to store gaming paraphernalia, including control devices, such as joysticks or mouse devices, CD ROMS, smart card reading devices, or other items. Spaces 2620 may also be used to store gaming paraphernalia or, preferably, a keyboard. FIG. 26b depicts the placement of an exemplary set of console devices in compartments 2610. In one embodiment, a personal computer is provided in subcompartment 2655, one console device, such as a Gamecube, is provided in subcompartment 2660, a second console device, such as a Playstation, is provided in subcompartment 2670, and a third console device, such as a XBOX, is provided in subcompartment 2675.

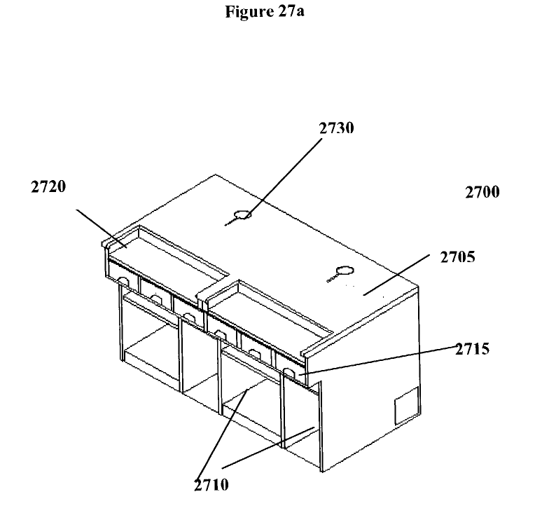

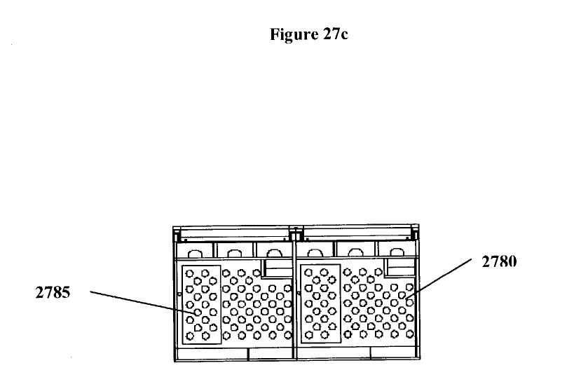

In a second embodiment, shown in FIG. 27a, the gaming station 2700 comprises a top surface 2705 and a plurality of compartments 2715, 2710. The station is preferably metallic or made of metallic looking material with rounded edges and, if made of metallic, a top surface coating to thermally insulate users from excessively cold surfaces. The compartments 2710 are used to store gaming devices, such as console players or personal computers. Compartments 2715 are used to store gaming paraphernalia, including control devices, such as joysticks or mouse devices, CD ROMS, smart card reading devices, or other items. Spaces 2720 may also be used to store gaming paraphernalia or, preferably, a keyboard. FIG. 27b depicts the placement of an exemplary set of console devices in compartments 2710. In one embodiment, a personal computer is provided in subcompartment 2755, one console device, such as a Gamecube, is provided in subcompartment 2760, a second console device, such as a Playstation, is provided in subcompartment 2770, and a third console device, such as a XBOX, is provided in subcompartment 2775. A plurality of ports 2730 can be used to pass cabling that attaches peripheral devices, such as joysticks or other controllers, or switches to allow a user to switch between different video and/or audio inputs.

Shown in FIG. 27c, the compartments 2710 may be enclosed by covers 2780, 2785, preferably metallic, having a plurality of holes. The holes act as a cooling or ventilation system permitting outside cooler air to circulate through the compartments 2710 and displace air heated by the operation of the personal computer or console devices. Preferably, the covers are structured as a larger cover 2780 in combination with a smaller cover 2785. The larger cover 2780 is locked in place to encase the gaming devices such that users cannot remove the gaming devices from their compartments. The smaller cover 2785 can be opened, as a door, to allow users to access the gaming devices and insert CD ROMS. In one embodiment, the larger cover 2780 is integrally formed with the gaming station 2700 and the smaller cover operates as a hinged or sliding door that may be manipulated using a handle. The smaller cover preferably includes a lock and latch mechanism. One of ordinary skill in the art would appreciate that a different type of cover could be used, in combination with any ventilation system, including a fan or a plurality of slits, vents, or other openings.

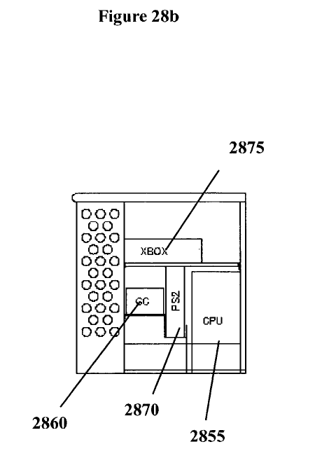

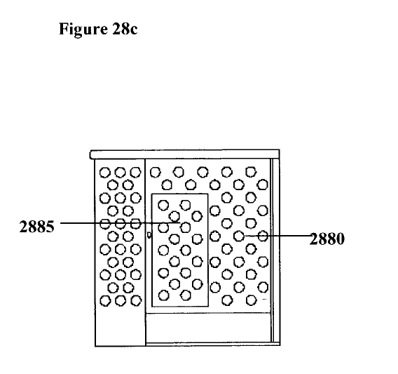

In a third embodiment, shown in FIG. 28a, the gaming station 2800 comprises a top surface 2805 and a plurality of compartments 2815, 2810. The station is preferably metallic or made of metallic looking material with rounded edges and, if made of metallic, a top surface coating to thermally insulate users from excessively cold surfaces. The compartments 2810 are used to store gaming devices, such as console players or personal computers. Spaces 2820 may also be used to store gaming paraphernalia or, preferably, a keyboard. FIG. 28b depicts the placement of an exemplary set of console devices in compartments 2810. In one embodiment, a personal computer is provided in subcompartment 2855, one console device, such as a Gamecube, is provided in subcompartment 2860, a second console device, such as a Playstation, is provided in subcompartment 2870, and a third console device, such as a XBOX, is provided in subcompartment 2875. A plurality of ports 2830 can be used to pass cabling that attaches peripheral devices, such as joysticks or other controllers, or switches to allow a user to switch between different video and/or audio inputs.

Shown in FIG. 28c, the compartments 2810 may be enclosed by covers 2880, 2885, preferably metallic, having a plurality of holes. The holes act as a cooling or ventilation system permitting outside cooler air to circulate through the compartments 2810 and displace air heated by the operation of the personal computer or console devices. Preferably, the covers are structured as a larger cover 2880 in combination with a smaller cover 2885. The larger cover 2880 is locked in place to encase the gaming devices such that users cannot remove the gaming devices from their compartments. The smaller cover 2885 can be opened, as a door, to allow users to access the gaming devices and insert CD ROMS. In one embodiment, the larger cover 2880 is integrally formed with the gaming station 2800 and the smaller cover operates as a hinged or sliding door that may be manipulated using a handle. The smaller cover preferably includes a lock and latch mechanism. One of ordinary skill in the art would appreciate that a different type of cover could be used, in combination with any ventilation system, including a fan or a plurality of slits, vents, or other openings. One would further appreciate that the relative configuration of the personal computer and console devices can be done in any manner, provided sufficient space is permitted between each device and between each device and the gaming station to permit the systems to cool down.

3. Interactive Gaming Network

Referring now to FIG. 5, a network 510 in accordance with a preferred embodiment of the present invention is illustrated. Each network access device 490, typically a personal computer or a console game, is connected to a network 510. The network access device 490 provides each user access to games or to other applications, such as educational applications, and the network 510 monitors the conduct of the user, including access time and performance levels, and integrates the activities of one user with a plurality of other users. One of ordinary skill in the art would appreciate that, within a conventional client-server network models, the network access device 490 (client) provides the user with certain base application functionality and communicates the activities of the user conducted within that application to a central server 515. The central server 515 receives a plurality of such communications from multiple users and integrates such communications to produce a unified representation of the activities of multiple users. The central server 515 then communications that unified representation to each of the user's network access devices 490. The integrated result is displayed to the user through the network access device 490. The user, seeing the integrated result, then performs a subsequent action, which is captured by the network access device 490 and communicated to the central server 515 once again.

Connected to the network 510 and in communication with the central server 515 are several peripheral devices and connections that provide additional functionality to users. Exemplary peripheral devices include printers 582, read/write CD ROMS 580, point of sale servers 583, network lines 589, such as T1 lines, for shared or dedicated access to an external network, voice over packet gateways 587, backup servers 585, and an independent audio system 586. The printers 582 are both color and black and white printers and are accessible to users from the network access devices 503 for the printing of scores, personal pictures, or any other documents or images. The read/write CD ROMs 580 provide users with access to additional information or with the ability to write personal information, games, music, or other data onto a CD. The point of sale servers 583, provide users with the ability to purchase products and/or services over the local network and/or the Internet. The network lines 589 put the network 510 in communication with external networks, the Internet, or other Interactive Services Facility networks. The voice over packet gateways 587 provide users the ability to communicate to individuals using a circuit switched network, such as the public switched network, through a network access device 503 and over the network 510. The backup servers 585 store certain information generated by users on the network 510. The independent audio system 586 can be used to take audio signals, generated across the network 510, and either transmit those signals through speakers or integrate those audio signals with audio signals from the independent audio system 586.

The present invention preferably integrates this conventional client-server system with the AV infrastructure of a movie theater complex, or other Existing Facility. The central server 515 communicates the integrated result as an input 535 to a multiple-input splitter 530, or, optionally, multiple-input splitter and amplifier, that also receives an AV input 536 from video cameras 540 positioned throughout the Interactive Services Facility. Outputs 537 from the splitter 530 are connected to a plurality of controllers 547, each associated with one or a coordinated combination of projectors 545. Each controller 547 operates to activate or deactivate its associated set of projector(s) 545 and to select a received output 537 to send to its associated set of projector(s) for projection 545 onto the central screen [not shown] and to send the audio system [not shown] of the Interactive Services Facility. The controllers 547 are, in turn, activated and controlled by a switching station 532 that operates to determine which set of projectors 545 are activated and which inputs 535 are to be projected and sent to the audio system.

One of ordinary skill in the art would appreciate that the present invention, although depicted as the integration of two independent networks, an AV network and a computer/digital network, through splitters, could be facilitated by the integration of an AV network directly into the digital network itself. The plurality of video cameras, provided throughout a sectioned area, could comprise digital video cameras capable of inputting their digital signals directly into a network through a digital connection. The network may include a central server and/or host computer with an application designed to track, catalog, and manage the digital signals received from the plurality of video cameras. In such a system, the splitters may be replaced by a host computer capable of selecting one or more digital signal streams inputted into the network, the streams including substantially all network activity. The host computer could then transmit the selected digital signals to one or more controllers capable of selecting one or more projector combinations. Additionally, in a presently preferred embodiment, the digital signals will stored so that they may be simultaneously broadcast or streaming to gamers and other interested parties outside of the Interactive Service Facility via the Internet or other communication network (e.g. LAN).

In the operation of one embodiment of the present invention, three sets of Proxima or Proxima-type projectors are provided in the back of the Interactive Service Facility. A plurality of video cameras are positioned throughout the Interactive Service Facility and focused on users and audience members. The client-server network generates a digital output that is sent through cabling to a splitter that splits the output, optionally including an amplifier to boost the signal, and sends it to each of the three controllers. Three controllers also receive signals, which were previously passed through a plurality of splitters and, optionally, amplifiers, from the plurality of video cameras. The first controller controls the first set of projectors; the second controller controls the second set of projectors, and the third controller controls the third set of projectors.

The first projector set comprises one Proxima projector positioned and programmed to project an input received from the first controller onto the entire screen. The second projector set comprises two Proxima projectors, one positioned and programmed to project one input received from the second controller onto half of the screen and the second positioned and programmed to project a second input received from the second controller onto the other half of the screen. The third projector set comprises four Proxima projectors, one positioned and programmed to project one input received from the third controller onto the upper right quadrant of the screen, the second positioned and programmed to project another input received from the third controller onto the lower right quadrant of the screen, the third positioned and programmed to project another input received from the third controller onto the upper left quadrant of the screen, and the fourth positioned and programmed to project another input received from the third controller onto the lower left quadrant of the screen. One of ordinary skill in the art would also appreciate that the Interactive Service Facility may additionally or alternatively include an entirely digital projector system, as compared to a traditional celluloid-based projection system, as the movie industry has already started to film, deliver and project movies using digital technology (e.g. THE PHANTOM MENANCE was presented digitally on select screens).

In communication with the controllers is a switching station. To use the system, an operator selects a projection configuration (full screen, half screen, or quarter-screen) and selects the video sources (specific video cameras and/or the server output) and programs the switch accordingly. One of ordinary skill in the art would appreciate that any type of projector capable of receiving and projecting digital inputs could be used and that such projectors could be combined into any combination to create any type of split-screen configuration. Further, any type of video input could be used, including multiple outputs from the client-server networks and inputs directly from the Internet.

Concurrent to the projection of a video input onto the screen, the activated controller sends the audio associated with the selected video to the audio system. Optionally, the audio may be supplanted by popular music, advertising, announcements, or other sounds that may or may not coordinate with the video being displayed. In such cases, the users would use headphones, plugged into the network access devices, to privately listen to the audio that properly accompanies the video being displayed.

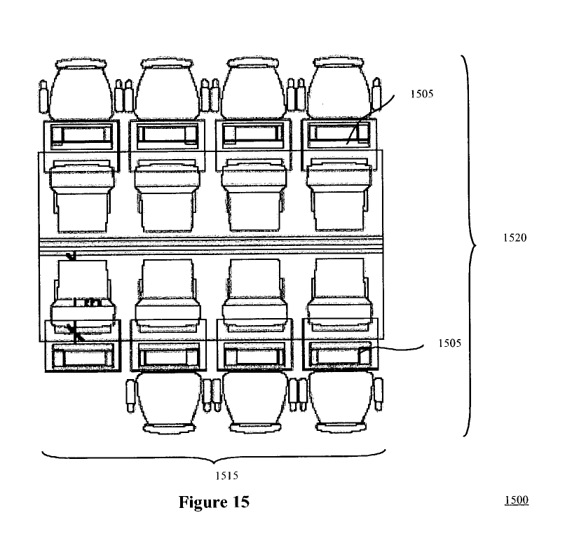

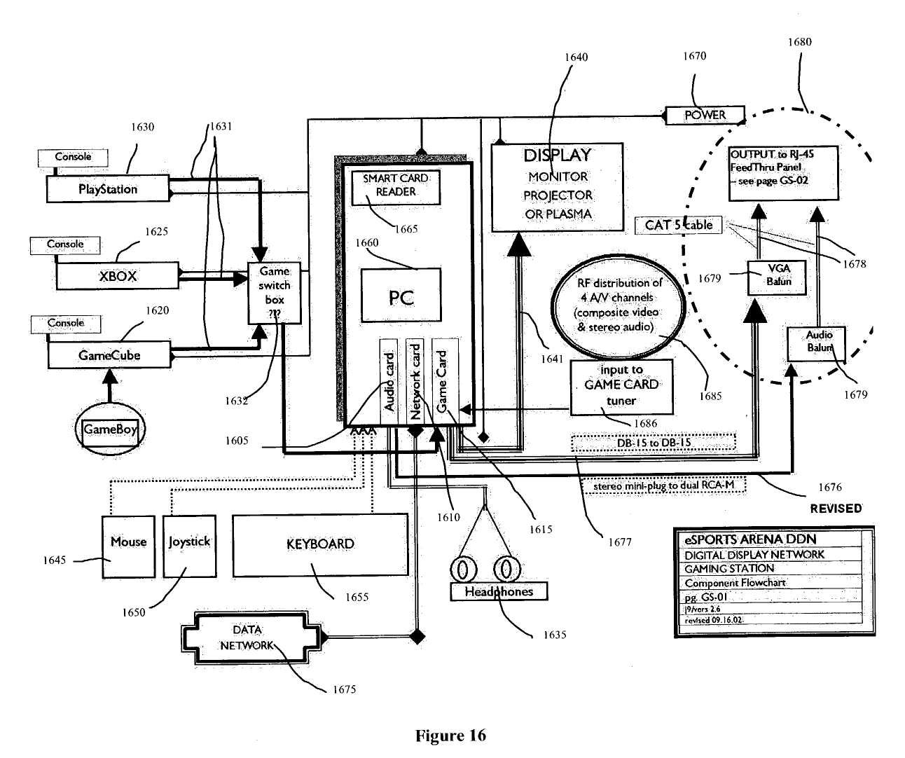

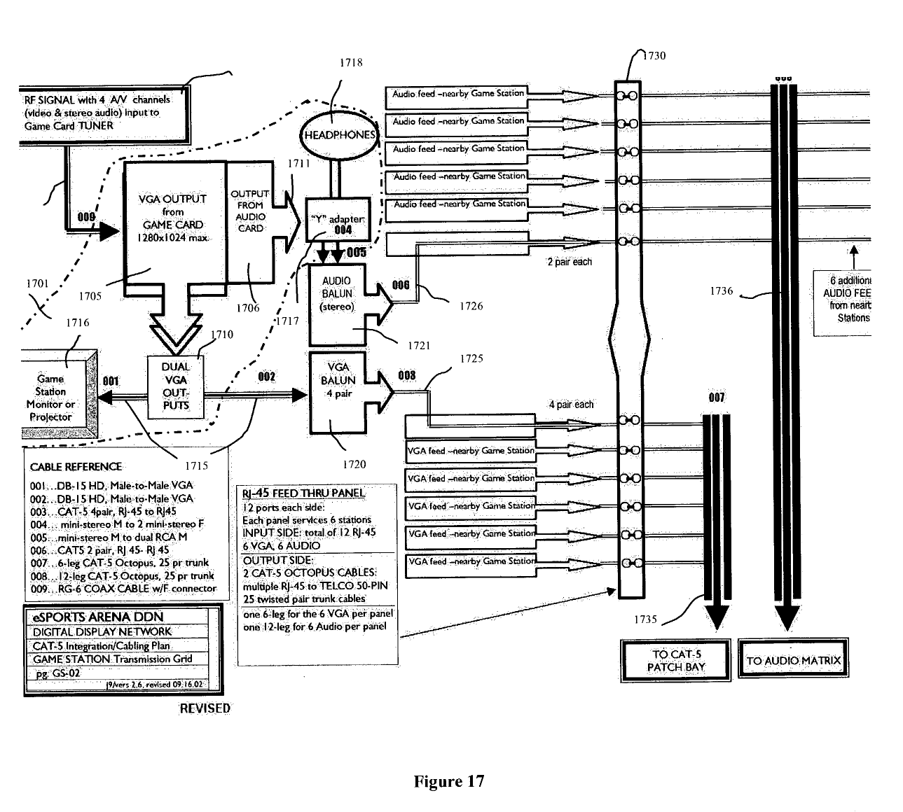

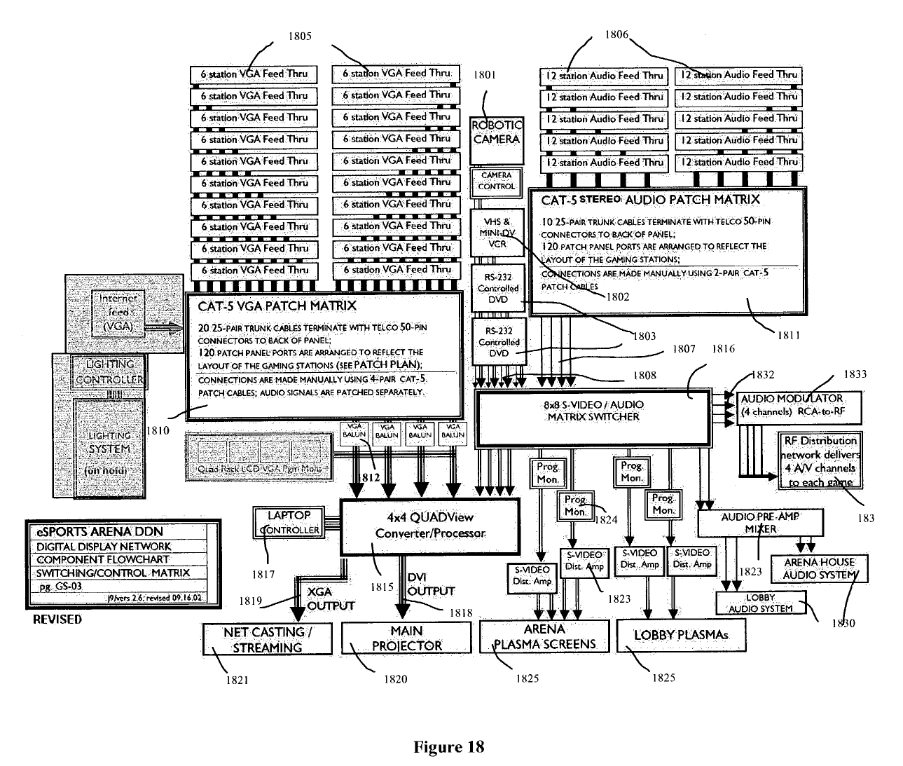

FIGS. 16 through 19 show an exemplary cabling plan of an AV network, hereinafter referred to as a digital display network (DDN), that communicates the audio-video information, representative of the gaming and/or other interactive activities of the users, from a plurality of gaming stations and/or additional devices onto a plurality of display systems such as the front projector screen within the ISF, a plurality of plasma screens, program monitors and/or TV monitors and also onto a plurality of audio speaker systems installed at various locations within and/or outside the interactive services facility. The DDN also, preferably, allows for the transmission, and/or display of the plurality of audio/video signals, generated from a plurality of gaming stations and/or additional devices, on to other networks such as public Internet for net casting, CATV networks, RF (radio frequency) networks for TV broadcasting and other required transmission activities. FIGS. 17 and 18, particularly, show how the audio and video information from a plurality of gaming stations is integrated and then transmitted to a central switching system for further processing and/or customized transmission.

Referring now to FIG. 16, a gaming station is shown in simultaneous communication with a data network 1675, through a network interface card 1610, and a DDN 1680 through audio 1605 and game 1615 cards. As already noted earlier, the data network 1675 and the DDN 1680 may or may not be two independent networks. The IGS 1600 comprises a plurality of network access devices that in the present embodiment comprise a conventional personal computer 1660 and a plurality of console gaming devices such as the GameCube 1620, XBOX 1625 and PlayStation 1630 gaming consoles. The gaming consoles are connected, through data buses 1631, to a game switch box 1632 that acts as an interface between the gaming consoles and game card 1615, allowing a user to switch amongst a plurality of games provided by the consoles. The gaming video information from the game card 1615 is transmitted through a conventional coaxial VGA (video graphics array) cable 1641 to display monitor 1640 installed on and/or at a short distance from the gaming station.

Also, shown are a plurality of ancillary devices such as a smart card reader 1665; a pair of headphones 1635 receiving audio signals from the network accessing devices through an audio card 1605; a plurality of input devices such as a mouse 1645, a joystick 1650 and a keyboard 1655 for allowing a user to interact with the PC 1660; and a network interface card 1610 that integrates the network accessing devices with the data network 1675. The audio and game cards, 1605 and 1615, allow the gaming station to communicate audio and video data with the DDN 1680 via cables 1676 and 1677 respectively. An AC/DC source 1670 provides ample power to gaming station. Additionally, a suitable distribution network, such as the RF (radio frequency) network 1685, is used to deliver audio and/or video information from additional devices, like cameras (installed at various locations) and VHS/DVD players, to each gaming station equipped with the game card 1615 via a tuner 1686. In a preferred embodiment, the RF network 1685 uses coaxial cables.

Referring to FIG. 17, the DDN uses conventional coaxial audio and VGA (Video Graphics Array) cables for the transmission of audio and video data to short distances such as to display unit(s) and headphones 1718 installed at the gaming station. However, for transmitting audio and video data, received and integrated from a plurality of gaming stations, over longer distances, to centralized switching stations, it is preferred to use an appropriate multiple pair twisted wire cabling system, such as the CAT-5 cabling system. CAT-5 cabling offers a relatively better cost versus throughput advantage when used for longer distance transmissions, in comparison to coaxial cables, while at the same time being less bulky and convenient to handle. Persons of ordinary skill in the art, however, would understand how use other twisted pair cabling systems specified under various standard categories by the ANSI/EIA (American National Standards Institute/Electronic Industries Association), fiber optic cabling systems, coaxial cabling and/or hybrid fiber coaxial cabling (HFC) system or any other cabling system known in the art.

Referring again to FIG. 17, the video output 1710 from the game card 1705 is first transmitted over VGA cables 1715 to the gaming station display monitor 1716 and also for short distances to a VGA balun 1720 that integrates the coaxial VGA cabling system with the twisted pair CAT-5 (4 pair) cabling system of the DDN 1700 by attuning the signal information received from the VGA cable 1715 to make it compatible with the CAT-5 cables 1725. The VGA cables 1715 are connected to the gaming station and the balun 1720 using suitable connectors, such as DB-15 connectors, at both ends. The CAT-5 cables 1725 use the conventional Registered Jack (RJ) connectors, such as the RJ-45 connectors, to connect to the VGA balun 1720 at one end and to an RJ-45 Feed-Thru panel 1730 at the other end. Similarly, audio output 1711 from the audio card 1706 is transmitted over audio cable, having stereo mini plug and dual RCA connectors, for a short distance (such as to a headphone system 1718 through an optional adapter 1717) and then passed over to CAT-5 (2-pair) cable 1726 to the RJ-45 Feed-Thru pane 1730 via an audio balun 1721. Since, video information requires higher bandwidth for transmission in comparison to audio information, therefore, in the presently preferred embodiment, the CAT-5 cables 1725 utilized for transmitting video data preferably use more number of twisted wire pairs (example 4) in comparison to the number of such pairs (example 2) used in cable 1726 for transmitting audio data.

The Feed-Thru Panel 1730 acts as an inline coupler for a plurality of audio and video transmission cables from a plurality of gaming stations. In the presently preferred embodiment, the Feed-Thru Panel 1730 comprises twelve RJ-45 female input ports in order to receive a pair of CAT-5 audio and video feed cables 1725 and 1726, each, from six gaming stations. The six video CAT-5 feeds 1725 are collated at the output of the panel with a suitable six-leg octopus cable 1735 such as a six RJ-45 to TELCO 50-pin 25 twisted pair trunk cable. However, twelve audio CAT-5 feeds 1726, six from panel 1730 and another six from a similar nearby panel, are collated with a twelve-leg RJ-45 to TELCO 0-pin 25 twisted pair trunk cable 1736. The trunk cable for carrying audio data supports audio signals from more number of gaming stations (example, twelve) since audio data requires less bandwidth for transmission in comparison to video data.

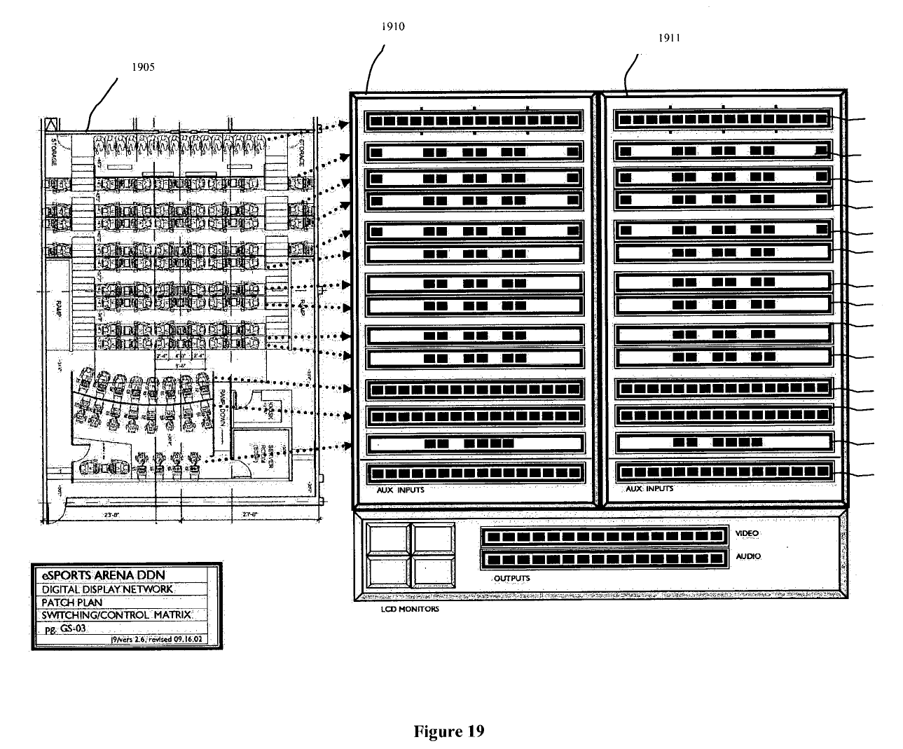

As shown in FIG. 18, the two audio and video trunk octopus cables 1805 and 1806, one carrying six video feeds from six gaming stations and the other carrying twelve audio feeds from twelve gaming stations, further connect to the audio and video patch matrix bays, 1810 and 1811 respectively. FIG. 19, shows an exemplary interactive services layout 1905 and a corresponding patch port plans for the audio and video patch matrix bays, 1910 and 1911, respectively. In the present embodiment, the audio and VGA patch matrix bays, 1910 and 1911, support one hundred and twenty patch ports corresponding to an equivalent number of gaming stations. It is preferred that the layout of the audio and video patch ports, 1910 and 1911, be reflective of the layout of the gaming stations in the ISF 1905. Thus, while the layout and number of patch ports in rows 1 through 10 and row 13 exactly match with the existing layout of the interactive services facility 1905, rows 11, 12 and 14 reflect the layout of a certain number of maximum gaming stations that can be feasibly housed in the corresponding area of the interactive services facility 1905. One of ordinary skill in the art would appreciate that the total number of audio and video trunk octopus cables and therefore the total number and layout of corresponding input patch ports, in the audio and VGA patch matrix bays respectively, depends upon the total number and layout of gaming stations installed within an ISF.

Referring back to FIG. 18, the audio and VGA patch matrix bays, 1810 and 1811, can be used to display and communicate video and audio data, selectively, on to a plurality of channels and over a plurality of devices within or extraneous to the interactive services facility. This is achieved by allowing a plurality of ports, on the VGA patch matrix bay, to be patched simultaneously for connecting to a suitable switching device that controls and manages customized display of input signals over a plurality of display devices and/or transmission channels. The switching device could be a computer running a suitable switching software or a special purpose routing/switching device known to persons of ordinary skill in the art.

In one exemplary embodiment, an operator can manually select and patch up to four video signals at an instance, out of the total number of available ports on the VGA matrix 1810, and input the four signals simultaneously to a suitable quad view. processor 1815 for display. The four video signals are transmitted, to the processor, partly over CAT-5 cables and finally over coaxial VGA cables via corresponding baluns 1812. The quad view processor 1815 is a multiple display image processor, known to persons of ordinary skill in the art, which can simultaneously project up to four video input signals over the quadrants of a screen. The processor can be controlled, either manually through a panel board or through an RS-232 serial port using a computer 1817, to either provide DVI (Digital Video Interface) outputs 1818 to a digital projector 1820 for further video display and/or convert the VGA input(s) to XGA (extended graphics array) output 1819 that can be provided to a media server 1821 for further streaming or casting over the Internet and/or private networks.

In the present embodiment, the quad view processor/converter 1815 is also receiving input signals from a S-Video/Audio switching system 1816. The matrix switcher 1816 is a device known to persons of ordinary skill in the art that allows connecting multiple video and/or audio sources (example, cameras, computers, VCRs, laser disc players, stereo receivers) to multiple receivers (example, projectors, computers, VCRs, P.A. systems). It acts as a signal management system simplifying the process of handling signal routing by providing a means of routing source signals to any one or any number of receiving devices, essentially creating a matrix pattern of interconnection possibilities. The S-Video/Audio matrix switcher 1816 controls and manages at least two categories of signals. One category of signal comprises a plurality of audio signals 1807 received by patching a plurality of audio ports on the audio patch matrix bay 1811. Another category of signal comprises a plurality of audio and/or video signals 1808 received from a plurality of additional devices. In the present embodiment, such additional devices comprise a plurality of stand-alone and/or computer controlled digital cameras 1801 installed at various locations within the interactive services facility in order to capture the interactive events and/or associated activities from the ISF for further live broadcasting to TV/CATV stations/head-ends and/or recordation of events for future playback transmissions; a plurality of conventional video cassette recorders (VCRs) 1802 and/or a plurality of computer controlled (through RS-232 ports) DVD audio/video players 1803.

In the present embodiment, signals 1808 from the additional devices are routed over to the quad view processor 1815 and then to suitable systems, such as projectors, media servers, RF antennas, for further display over projector screen(s), transmission over Internet and/or TV broadcasting. Similarly, the audio signals 1807 from the patch matrix bay 1811 and/or the audio/video signals 1808 from the plurality of additional devices are transmitted, via optional monitors 1824 and audio/video amplifiers 1823, for display and communication over a plurality of display systems 1825 (example, plasma screens installed within interactive services facility and/or in the lobby) and/or audio systems 1830 (example, audio systems installed within the interactive services facility arena and/or in the lobby of the interactive services facility) installed at various locations within and/or outside the interactive services facility.

The present embodiment also allows for the transmission of a plurality of audio/video channels 1832, example four, from the matrix switch 1816 to the game cards of each gaming stations. The signals are transmitted, through a suitable modulator 1833, over a suitable distribution network 1835, such as the RF (radio frequency) network, allowing the users at the gaming stations to tune in to a required audio/video channel for personal preferential use.

The system illustrated in FIG. 5 is preferably installed to enable gaming operations within a sectioned area of a movie theater complex, or in any other facility. In accordance with another aspect of the present invention, however, it is preferred to provide gaming operations in multiple facilities so that, for example, two gamers can compete against each other from remote locations. In this case, the system illustrated in FIG. 5 is preferably provided in each facility to enable the gaming operations in each facility. It is further preferred to interconnect the networks provided at each facility, as illustrated in FIG. 5A.

In FIG. 5A, Gaming Facility A 550, Gaming Facility B 552 and Gaming Facility C 554 are connected to the Internet 556 via connections 558, 560 and 562, respectively. These interconnections are made in accordance with standard techniques of connecting to the Internet, which are well known to those of ordinary skill in the art. The facilities 550, 552 and 554 are preferably also interconnected via dedicated lines. Line 564 interconnects Gaming Facility A 550 and Gaming Facility B 552. Line 566 interconnects Gaming Facility B 552 and Gaming Facility C 554. Line 568 interconnects Gaming Facility A 550 and Gaming Facility C 554. These dedicated lines 564, 566, and 568 are preferably leased point-to-point connections that ensure the appropriate level of connectivity and data transfer between the various gaming facilities so that a gaming experience involving users at different gaming facilities that are geographically distinct from one another is optimized.

While the preferred mode of modifying a movie theater complex in accordance with the present invention has been disclosed and described above, other means and methods of modifying or providing seating structures and game housing structures are contemplated by this invention. For example, in a movie theater, the seats can be removed and a seat and game housing structure can be provided. Where other Existing Facilities are being repurposed, it may not be necessary to remove any items, and a new seat and structure to house the gaming equipment may be provided, or, alternatively, whatever structures are present can be removed and a seat and gaming structure provided. The important considerations in inserting interactive gaming service stations in accordance with the present invention is to provide a user assigned to a specific interactive gaming service station with unimpeded access to that station, and providing seating that allows a user to flexibly view both the screen and interactive gaming service station either alternately or concurrently. Additionally, such a configuration may be achieved by removing additional seats or rows to provide greater space, or greater density, depending on preference.

While the present invention has been described with respect to a movie theater complex, it has already been noted that other types of Existing Facilities can be modified in accordance with the present invention. The other types of Existing Facilities may also have sectioned areas, like a movie theater complex. Further the sectioned areas of other Existing Facilities may, or may not, have existing seating structures that can be modified in the previously described manner. If there are no existing seating structures, then an entirely new structure of seats and an interactive gaming structure can be provided in accordance with the present invention. It is further possible that an Existing Facility may have no sectioned areas, and may just be a shell. In this case the seating structures, the interactive gaming structure and other facilities can be introduced into the shell or into a partitioned or sectioned area introduced into the shell.

In accordance with a preferred embodiment of the present invention, the main goal of a re-purposed Existing Facility is to provide a gaming experience. It should be apparent, however, that the re-purposed Existing Facility can be used for alternative uses, in addition to gaming. For example, the re-purposed Existing Facility and the networked Computer technology could also be conveniently and efficiently used to provide educational seminars or classrooms, computer training, corporate events as well as for other purposes. In accordance with a preferred embodiment of the present invention, these activities are offered on a fee basis during “off-times” when usage of the facilities by gamers would be minimal.

B. Operational Systems and Methods For the Delivery of Interactive Gaming Services Within the Interactive Services Facility.

In addition to adapting a sectioned area of an Existing Facility to create an Interactive Services Facility (ISF), it is preferred that certain operational systems, used throughout the Existing Facility and not limited to a single sectioned area, are adapted to enable the cost-effective and efficient operation of the Interactive Services Facility.

Referring back to FIG. 1, an Existing Facility 110., comprising a plurality of sectioned areas 120, conventionally has a ticketing system 180 and concession stand 160 wherein food and beverages are dispensed. The ticketing system 180 conventionally comprises a ticket-dispensing machine 187, manned by a human operator, networked to a ticket inventory and accounting system 189. Optionally, the Existing Facility 110 may also have an automated ticket-dispensing machine 191 that displays available service options, receives and processes cash, credit card, debit card, or ATM card charges, and dispenses tickets. An individual may be stationed at the Existing Facility 110 entrance to inspect and accept tickets. Conventionally, the concession stand 160 comprises a set of cash registers, cases for the display of foods, freezers for the storage of ice-cream products, drink dispensers, and food machines, such as popcorn poppers, hot dog grillers, or other machines for the creation of hot foods.

1. Accessing An Interactive Service Facility

Referring now to FIG. 6, in a preferred embodiment, the ticketing system 680 now includes an additional, yet integrated, interactive services ticketing system. The integrated ticketing system includes an additional inventory database 621 that is resident within the existing ticket inventory and accounting system 689 and is capable of being accessed by an operator in the ticketing booth. Once accessed, the existing ticket dispensing machine 687 dispenses an Interactive Service Facility ticket. Preferably, the integrated ticketing system further includes at least two automated interactive service facility smart card machines 623, one accessible to users from the exterior of the Existing Facility 610 and proximate to a conventional automated ticket dispenser 691 and one accessible to users at the entrance to the Interactive Services Facility 628. The integrated ticketing system further preferably includes a smart card issuance booth 627 at the entrance of the Interactive Services Facility 628.

In accordance with the present invention, admission to the Interactive Service Facility within the Existing Facility can be ticketed in a number of ways. In a first embodiment, a flat rate can be charged for admission into the Interactive Service Facility. Alternatively, admission can be ticketed for a period, for example, for two hours, based on a set fee. As described in more detail below, once a gamer enters the Interactive Service Facility, the gamer's usage of various facilities within the arena are preferably be monitored and timed. For example, the following data is preferably maintained for each gamer: (1) the amount of time in the Interactive Service Facility; (2) the amount of time at Interactive Gaming Stations; (3) the amount of time playing each game; (4) the amount of time using other provided facilities within the Interactive Service Facility and/or Existing Facility; (5) date and time logs for all activities. Billing can be based on any of the above measured data. For example, the fee can be based solely on entry into the arena, by time logged onto a personal computer or a gaming console or by time actually playing a game. Alternatively, billing can be based on combinations of the above parameters. For example, entry into the Interactive Service Facility could be billed at one rate, while time in an Interactive Gaming Station or time playing a game could be billed at another rate. It is also preferred to allow gamers to access the billing information and to allow gamers to determine how much credit they have left in their account. It is further preferred to apprise gamers when their credits are about to expire. This can be done with a timer display or other display that either is always displayed or is popped up by the gamer.

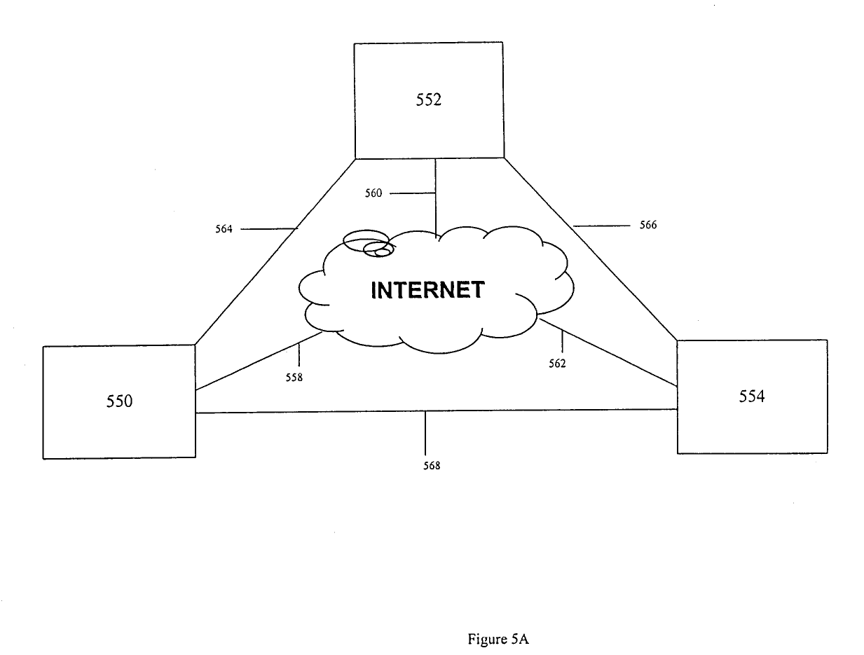

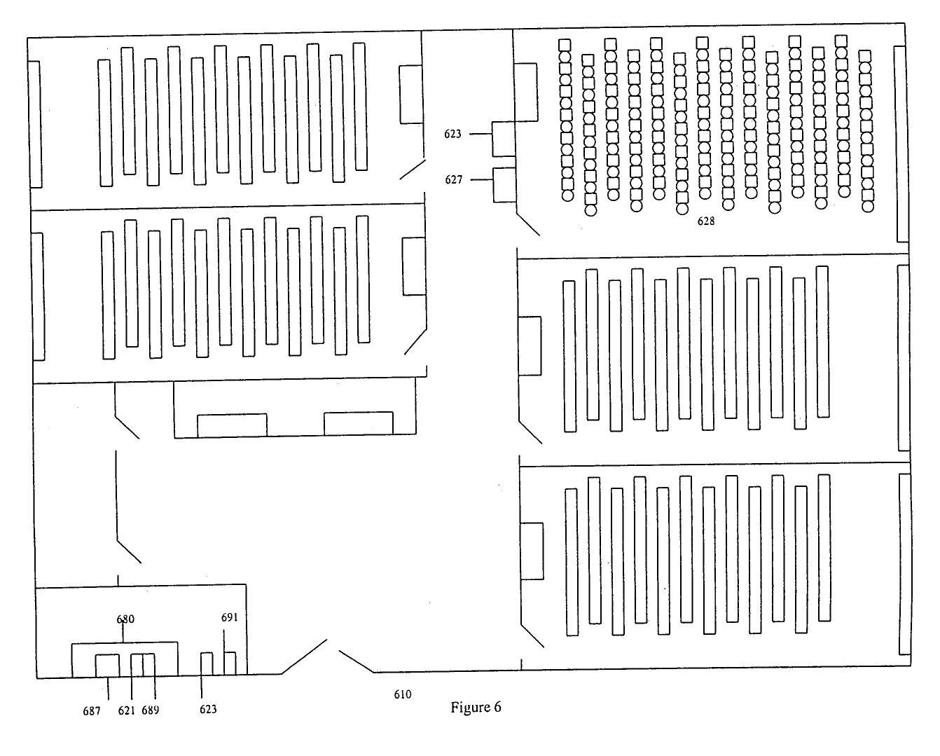

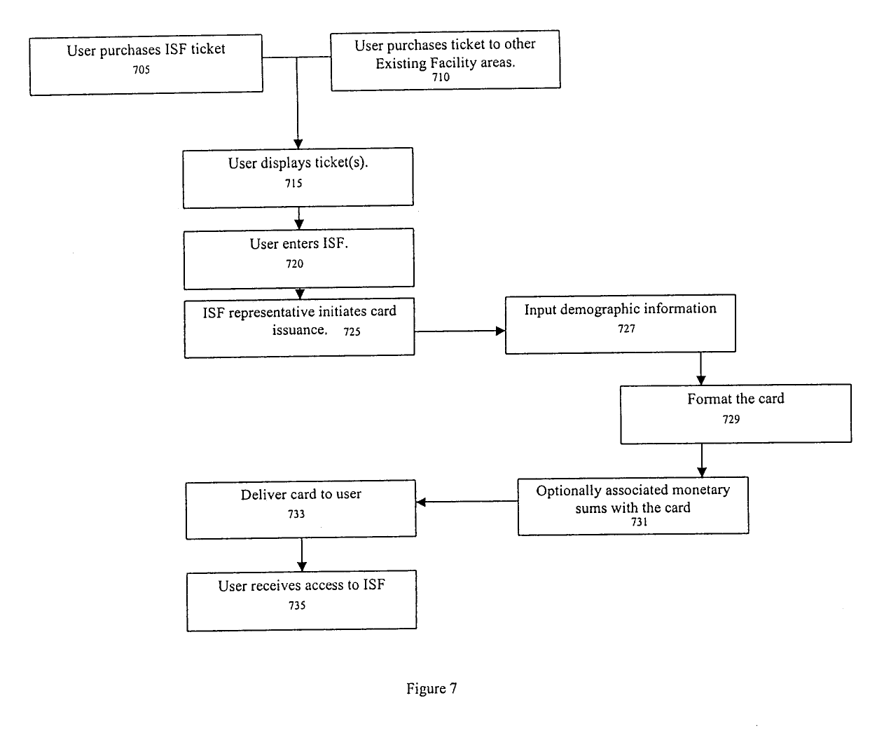

Operationally, as shown in FIG. 7, a new user approaches the ticket booth of the Existing Facility and purchases 705 an Interactive Services Facility ticket that is dispensed from the existing ticket dispensing machine. The user may optionally also purchase 710 a ticket for admission or access to the other unmodified sectioned areas of the Existing Facility. In a presently preferred embodiment, it is desirable to enable to purchase of Interactive Service Facility tickets online, in addition to in person via the ticket dispensing machine or other conventional ticket booths. Once purchased 705, 710, the new user displays 715 the purchased ticket(s) to an individual stationed at the Existing Facility entrance to inspect and accept all tickets. The new user then proceeds 720 to the entrance of the Interactive Services Facility where an Interactive Service representative receives the new user's ticket and initiates 725 the issuance of a smart card, otherwise known as an Interactive Services Facility card, to the new user. The issuance process preferably comprises the inputting 727 of the new user's name, email address, and age, among other desired demographic information into a database, the formatting 729 of a smart card with that demographic information, the optional association 731 of additional monetary sums with the smart card, and the delivery 733 of that smart card to the new user.

Additionally, in a presently preferred embodiment, unique identification characteristics are additionally collected at this stage. For example, a photograph and/or fingerprint of a gamer may be taken and operatively associated with the smart card via the central server and network within the Interactive Service Facility. These unique characteristics may later be utilized to verify the identity of the user when he attempts to access and register at an Interactive Gaming Station using the web camera 409 and fingerprint reader 406 on the station. Once the smart card is received, the new user may enter 735 into the Interactive Service Facility.

In one embodiment, the time differential between when the user purchases a ticket and when the user checks into the interactive services facility is monitored. Where the time differential equals to, or is less than, a predetermined amount, the user is issued a smart card having a predesignated value, i.e. equal to the value of the purchased ticket. Where the time differential is greater than a predetermined amount, the user is issued a smart card having less than the predesignated value, i.e. equal to less than the value of the purchased ticket, in order to penalize the user for the delay. This allows operators of the interactive services facility to insure ticket buyers do not first see movies prior to entering the interactive services facility.

a. Interactive Services Facility Card—Smart Card

The smart card may be any type of credit card-sized device capable of holding limited information within a programmable, modifiable memory. Exemplary types of smart cards include magnetic stripe, laser read/write optical, smart memory, and integrated circuit (IC cards, which are available from vendors such as ACTIVCARD, BULL, ENTRUST TECHNOLOGIES and MOTOROLA). In a presently preferred embodiment, the smart card is designed as a modified compact disc (CD) and can be read and written to like any conventional CD. The smart card preferably includes a magnetic strip encoded with a unique identification key used to access the central server through the network of the Interactive Service Facility, and a data storage component or memory that is capable of storing user-specific data. Preferred smart cards have memories that can be modified to store, for future access, user's demographic and contact information, interactive service activities, reward points, and available credit line that could be used for purchases.

The automated interactive service facility smart card machines 623, as shown in. FIG. 6, are provided to enable users to automatically purchase entrance tickets and associate monetary balances with their smart cards. Preferred smart card machines display available service options, receive and process cash, credit card, debit card, or ATM card charges, and receive and update the memory of the user's smart card. Upon completion of the transaction, the smart card machines return the user's updated smart card and, if applicable, the user's credit, debit, or ATM card. As described in more detail below, when accessing, registering and using an Interactive Gaming Station, a gamer may alternatively utilize either the card reader 408 and/or read/write device to read and/or write to the smart card.

2. Accessing An Interactive Gaming Station

A plurality of users within the Interactive Services Facility can be assigned seats upon ticketing or upon entry into the arena, each seat being associated with a specific Interactive Gaming Station. Alternatively, users can be issued unrestricted tickets that allow them to select their own seats. Also, users can be restricted to gaming areas, the areas selected by one of a variety of methods, including the age of the user, the type of game, the type of console game, etc. As previously described, each Interactive Gaming Station is equipped with a network access device that is connected to a central server.

Depending on the interactive service being provided, the appropriate application is loaded onto the local memory of the network access device and registered with the server. Users can access the local application, activate it, and play in a multi-user environment, as controlled and managed by the server.

In a presently preferred embodiment access to all games or applications within the Interactive Service Facility and Interactive Gaming Stations are by the card reader and/or the fingerprint reader. Thus, a gamer would have to either insert their smart card into the card reader and/or use the fingerprint reader to gain access to games. Of course, conventional password access models may be additionally or alternatively utilized.

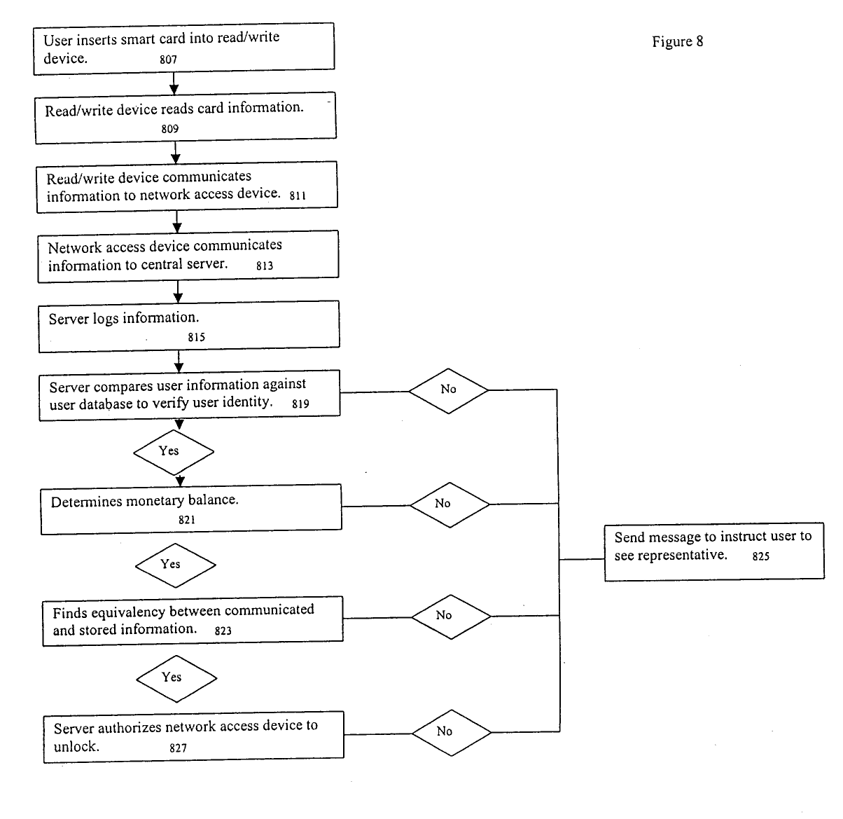

Referring now to FIG. 8, in a preferred embodiment, the interactive service being provided is a game, such as an action, adventure, sports, or other conventional video game. The user accesses the game, which is partially stored on the local memory of the network access device, by inserting 807 a smart card, as previously purchased and configured, into a smart card read/write device. Prior to insertion, the network access device is preferably in a locked state to prevent unauthorized users from activating a game and preferably displays a set of instructions informing a user to insert his smart card, or purchase a smart card if not already in possession of one, and insert it into the attached smart card read/write device.

Once the user inserts 807 his smart card into the read/write device, the read/write device reads 809 the information stored within the smart card and communicates 811 the information to the network access device. The communicated information preferably includes monetary balance, reward points, user name, and total prior user playing time. One of ordinary skill in the art would appreciate that any information storable on a smart card could be read and communicated by the read/write device. The network access device communicates 813 the received information, along with a unique identifier for the access device itself, to the central server, which logs 815 the received information and compares it against a user database to verify the user information. The user database entry is initially created upon the first registration and issuance of the smart card and is updated whenever a user accesses and uses a network access device or increases the monetary balance through the automated interactive service facility smart card machines.

Once the central server verifies the 819 user's identity, determines 821 the existence of a positive monetary balance, and finds 823 equivalency between the communicated information, namely monetary balance, reward balance, and prior user player time, and the comparable information stored on the database, the central server authorizes 827 the network access device to unlock and provide the user access to locally stored applications. If a photograph of the user is stored within the central server, that photograph may be shown or flashed on the central screen or monitor of the Interactive Gaming Station once the user has been authenticated to announce the arrival of a new player in a multi-player game, when applicable. Alternatively, the player may be announced, through video or audio, to the plurality of other users. Although the process is depicted serially in FIG. 8, one would appreciate that the information check can occur in parallel.

If the server fails to verify 819 the user's identity, determine 821 the existence of a positive monetary balance, or find 823 equivalency, the server sends 825 a message to the network access device to instruct the user to see an Interactive Service Facility representative. The server can optionally send a message to the representative instructing the representative to make a personal visit to the network access device that was assigned the unique identifier.

In another embodiment, a user's access to interactive services, such as games, may be controlled by placing the smart card reader in data communication with a personal computer, wherein the personal computer operates as a controller for a monitor. A plurality of gaming consoles is in data communication with a personal computer. Data streams from each of the consoles, or alternatively the personal computer, may be selected by operation of a switch or other channel selection means. Where a smart card is read and a server operates to authorize a user's access to gaming activity, the smart card communicates an approval signal to the personal computer. The personal computer, in turn, activates the monitor which, depending on the channel selected, can be used to display data streams from any of the connected gaming consoles or the personal computer. One of ordinary skill in the art would appreciate that this control mechanism can operate by utilizing any approval mechanism in data communication with a central controller that is in data communication with each gaming device. Once authorization is received, the controller can then unlock essential peripheral devices, such as a monitor, joystick, mouse, keyboard, or other input device, to enable the user to play the game.

Referring now to FIG. 9, the user, having obtained access 905 to the network access device, launches 907 the specific interactive service he wishes to engage, which, in this embodiment, is a game. Depending on the specific nature or characteristics of the game, the user may be prompted to specify one or more variables. For example, in multiplayer games, the user may be prompted to search for and/or select an opponent or opponents for the game. Alternatively, if the network access device is dedicated to a specific application, the application may independently launch upon receiving an instruction by the server to provide the user access.

Although certain games or applications may be immediately accessible through the Interactive Gaming Station as a result of local storage within the network access device or automatic access via the network, other games may require the user to take additional steps. For example, certain console gaming devices use specific game cartridges or CDs that need to be inserted into the gaming device itself in order to allow the user to access the game. As a result, the Interactive Service Facility will preferably include an automatic console game cartridge dispenser that is operatively connected to the network. Users desiring to access a specific console game cartridge will be prompted to use the dispenser. At the dispenser, the user will be prompted to select the specific game cartridge that he is interested in using through an interface provided on the dispenser. In order to obtain the cartridge, the user will be required to swipe his smart card through a reader provided on the dispenser, which is in communication with the central server. Assuming the user is authorized to checkout console game cartridges in general, or the specific console game cartridge that has been selected, the dispenser will make the cartridge available to the user. By requiring the user to provide his smart card identification, the Interactive Service Facility can better control access to the console game cartridges, monitor their use, appropriately bill and update user's records and minimize the risk of theft of these items.

In another embodiment, upon obtaining access to the network access device, a user is first offered a plurality of product and/or service offerings, including coupons, discounts, free items, gaming time, or contest eligibility, in exchange for providing data. The data may be obtained in a variety of ways, including an interactive web page having a plurality of dialog boxes wherein certain data, including opinions, demographic data, or other input is requested or a video, promotion, or other marketing item that may be displayed or played on a monitor.

After the user completes his gaming session 909 and terminates his use of the selected interactive service, the user logs off the system by engaging 913 a log-off icon displayed on the network access device. Upon receipt of a log-off request, the network access device displays 915 a dialog box asking the user to confirm the log-off request by clicking on a “yes” button or to return to using the interactive service by clicking on a “no” button. If the user clicks 917 on the “no” button, the network access device does not initiate 919 the log-off procedure and provides the user access to the interactive services once again. If the user confirms 921 the request to log-off, the network access device initiates the log-off procedure. The log-off request is transmitted 923 to the server and the network access device displays 925 an informational message requesting the user to wait as the system logs him off. The server, having received the log-off request, accesses 927 the user database that has the most recently updated versions of the previously communicated information. The information mirrors the information provided upon log-in and preferably includes monetary balance, reward points, user name, and total prior user playing time, each piece of information having been updated on a substantially real-time basis throughout the user's session by the network management system, to be described below. The server then sends 929 that information to the network access device. Upon receiving the information, the network access device instructs 931 the smart card read/write device to write 933 the received information onto the smart card inserted therein. After the read/write device conducts the writing process, it instructs 937 the network access device to display 939 an informational message to the user informing him that the session is complete and that he can remove his card.

If the user fails to wait for the entire log-off procedure to complete by, for example, taking his card out of the read/write device before the final write process completes, the read/write device should preferably send the network access device a message that the card was removed prior to a final update procedure. The network access device should then communicate that message to the server that, in turn, should store a log entry in the user database indicating the incomplete log-off state. Preferably, when the user logs-in in the future, the server will detect the incomplete state message and instruct the network access device to inform the user to see a representative (who may then use the stored user database information to update the card) or may perform the update process, as discussed above, prior to allowing the user access to the network.

3. Engaging An Interactive Gaming Service

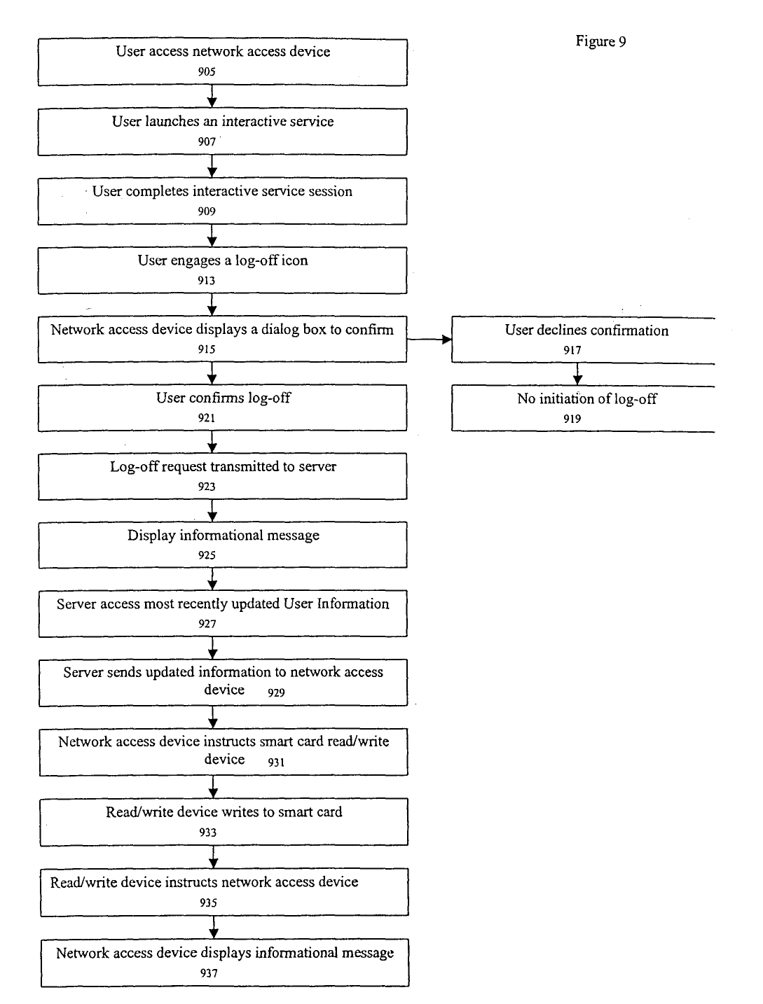

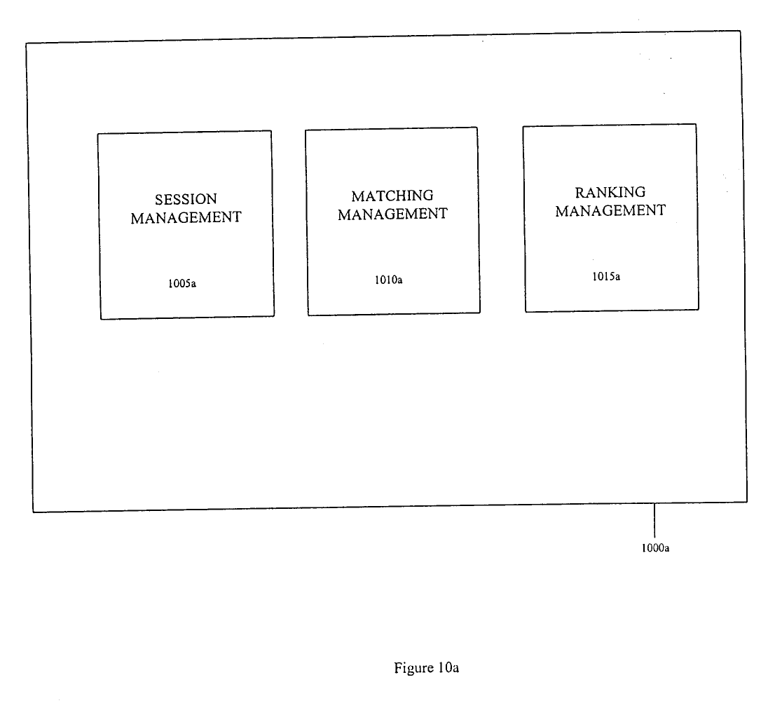

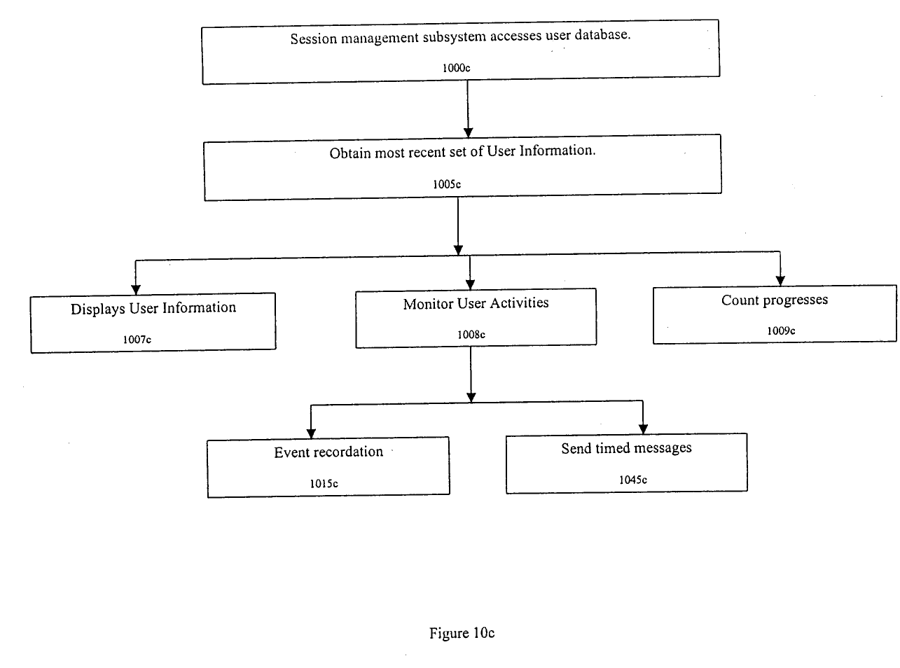

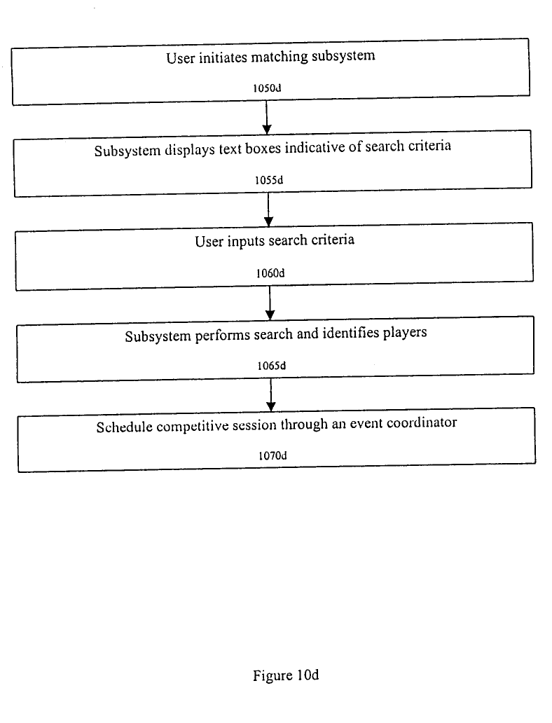

In the course of engaging the interactive service, the present invention provides for a network management system that improves the quality and type of services available. Referring now to FIG. 10a, the network management system 1000a comprises session management 1005a, matching management 1010a, and ranking management 1015a subsystems. The session management subsystem 1005a manages the substantially real-time update of session information, such as total playing time and the coordinated play among multiple users, and calculates, on a substantially real-time basis, the monetary balance left on a user's smart card. The matching management 1010a subsystem manages a user's search of suitable users to play against and the coordination of that competitive play. The ranking management subsystem 1015a manages the relative ranking of users who engage in competitive interactive services, such as games.

a. Session Management

The session management subsystem manages the substantially real-time update of session information, such as total playing time and the coordinated play among multiple users, and calculates, on a substantially real-time basis, the monetary balance left on a user's smart card. The event interface 1000b, as shown in FIG. 10b, monitors user events, including a user identification 1068b, when the user logs-on 1070b, the machine the user logs onto 1072b, the type of interactive service activated 1074b, the users' initial monetary balance 1076b, the monetary sum expended by the user in the course of the session 1077b, monetary sums added by the user in the course of the session 1079b, the other users 1086b against whom the user plays, the users' rank 1088b, and the user's demographic information 1090b (collectively referred to as User Information). One of ordinary skill would appreciate that substantially any event conducted through the network can be captured and displayed via the integrated event interface 1000b. Each portion of User Information is updated in substantially real-time with prior events being recorded in a user database of historical events. The event interface 1000b is preferably part of an application written, for example, in Visual Basic and preferably has a tool bar 1092b that provides for optional controls, including the ability to select what information to display and to restrict the display of certain information. The event interface 1000b is preferably designed to permit the display of multiple User Information blocks concurrently.

Operationally, as shown in FIG. 10c, the session management subsystem accesses 1000c the user database to obtain 1005c the most recent set of User Information once the user successfully logs onto 1000c into the system. The session management subsystem displays the User Information, initiates the monitoring 1008c of user activities, and initiates 1009c a count against which user monetary sums are deducted over time. For every clock increment, as determined by a pre-defined algorithm, the session management subsystem deducts a fixed amount from the monetary balance of the user.

For example, for every minute that elapses, the session management subsystem may deduct $0.10 from the prior monetary balance. While the deduction method has been described on a per minute basis, any deduction method could be used, however, including a per log-in basis, standard fixed-fee basis, per second basis, flat charge for entry into the Interactive Services Facility, per amount of time in the facility, per amount of time in a gaming seat, or per interactive service access basis, and any deduction amount could be associated thereto. It is appreciated that different deduction methods could be combined and different rates could be associated thereto. Moreover, the session management subsystem may store amounts owed by the user and deduct the totals, on a predetermined periodic basis, from an automated ACH debit established between the operators of the present invention and a user's financial account.

When a user launches an application and enters into a competitive multi-party interactive service, such as a game, the session management subsystem records 1015c that event and records 1015c the players against whom the user is competing. Concurrently, as shown in FIG. 10e, the server periodically communicates the status of each user's participation in the service, possibly including the users' scores or gains relative to other users, to the ranking subsystem, which will be described in more detail below. The session management subsystem can have a plurality of other features including the ability to send 1045c timed messages to the network access device for communication to the user, such as warnings that the monetary balance is running low and the session may terminate. In a presently preferred embodiment, a gamer will be promoted to replenish the monetary balance in his account that is associated with his smart card by (1) paying cash to an administrator who manually enters the increase into gamer's account on the central server, (2) inserting cash into one of the smart card machines to automatically increase the account balance associated with his account, or (3) using a credit or debit card to automatically increase the account balance associated with his account. In a presently preferred embodiment, these and other similar messages are sent to the network access device using a combination of an instant messaging system and through voice-prompts that can be heard by the gamer through the headphones provided at the Interactive Gaming Station.

One of ordinary skill in the art would realize that other types of information and data might be managed by the session management subsystem. For example, gamers may have particular or personalized configurations and settings (e.g. mouse, keyboard, screen settings) that they desire to use at the Interactive Gaming Stations which may be stored with their User Information in the central server and accessed each time the gamer initiates a new interactive gaming session. Gamers may be prompted to input these and other preferences when prior to their first interactive gaming session at the Interactive Service Facility, or alternatively, may be allowed to upload them from a memory (e.g. disk drive, Palm Pilot, file) using the read/write device provided on the Interactive Gaming Stations.

b. Matching Management

Users who wish to engage in a competitive interactive service where multiple users compete within the context of a virtual world need to find a suitable set of users to compete against. The matching management subsystem manages a user's search of suitable users to play against and the coordination of that competitive play. The matching subsystem comprises a searching utility capable of accessing a user database to search for criteria, set by the searcher, in identifying a suitable competitor and an event coordinator capable of sending requests to compete and scheduling said competitions. Referring to FIG. 10d, the user first initiates 1050d the matching subsystem by any conventional means, including clicking on a matching subsystem icon or link. The matching subsystem could be a distributed application, programmed in, for example, Visual Basic or C++, or a web page interface to an application resident on the network server. Once initiated, the matching subsystem displays 1055d a set of text boxes indicative of search criteria, such as name, age, class, rank, type of interactive service, among others. The search criteria can be used to identify one or more potential competitors. One of ordinary skill in the art would appreciate that any set of criteria can be used provided that such criteria is tracked and stored by an accessible database. After the user inputs 1060d the search criteria and the subsystem performs 1065d a search, comprising the comparison of the criteria against a user database and selection of those users from the database who meet said criteria, the user preferably schedules 1070d a competitive session with one or more identified users through an event coordinator. The event coordinator can be any type of notification and calendaring system, including, for example, an automated email request method that receives preferred competition times from the user and emails them to the identified competitors with a request to compete, a posting request method that receives preferred competition times from the user and posts the request to compete, together with a time, on a web page, or an automated calendaring request method that receives preferred competition times from the user, compares it against calendars that store available play time, as previously configured by the identified competitors, and automatically schedules a competitive session, if no conflicts recorded on the calendars exist. The event coordinator can have additional features, such as blocking competitive requests (an individual may designate that it will automatically refuse to play to certain other identified players) or automated requesting where requests to compete are automatically sent by a set of users to other users based upon pre-established criteria, such as rank.

One of ordinary skill in the art would realize that any conventional matching method may be utilized for the multi-player interactive gaming services provided for herein, and that such matching methods may vary depending on the type of game or play (e.g. non-tournament one-on-one, tournament one-on-one, team play, etc.). For example, for games selected to be played in non-tournament one-on-one mode, the matching management system accesses the central server as described above and identifies all of the currently available gamers that satisfy the selected criteria. Currently available gamers may include (1) local gamers within same Interactive Service Facility, (2) networked gamers located within a different, but connected, Interactive Service Facility and/or (3) Internet garners located at any other location. The availability of non-local gamers may be managed by simply having those gamers register and log into a central matching server within or shared by the Interactive Service Facility network. For gamers that have registered with the Interactive Service Facility and identified by the matching management system, it may be possible to access certain User Information, such as their profile, rank, picture etc. This User Information, along with other available information, may be used by the gamer to select one or more potential opponents. For example, when selecting between potential Internet gaming opponents, it may be desirable to include and be able to sort and select potential opponents based on bandwidth or other connectivity characteristics. Additionally, matching management system can be programmed to recommend potential opponents based on one or more specified factors. Once a potential opponent has been identified by the matching management system and selected by the gamer, a request or challenge is sent out to that potential opponent via the central server, and the potential opponent may elect to accept or decline the challenge. A similar process may be followed for team play, wherein gamers will also be required to identify and select potential teammates in addition to potential opponents.

For tournament play, the matching management subsystem may be programmed to operate automatically. The automated process may be based on a seeding process that uses the ranking subsystem, or may be done entirely at random. In a presently preferred embodiment, there is also a tournament management system that is used to enforce certain tournament-specific rules, such has how to start a tournament game (at the gamer's mutual consent, at a specific time, etc.), how to pause games, how to play (up to a score, time duration, etc.), how to determine who advances (single or double elimination, round-robin, etc.), and what happens in the event of a tie. The tournament management system may also be used to store or record certain portions or highlights of a game or match, otherwise known as demos, on the local hard drive of the network access device or on the central server so that gamers, fans and spectators (located within or external to the Interactive Service Facility) can access and review past and current matches at any time. It is also preferred to provide online advertising for tournaments at one of the gaming arenas. The advertising also preferably includes an entry form by which a gamer can apply for entry into the tournament via the Internet. The advertising for the tournament can also be provided for a tournament to be held at multiple arenas, with the entry form including the ability to specify which gaming arena the gamer desires to attend.

C. Reward and Fee Management

Once the matching process has been completed and an opponent(s)/teammate(s) selected by the gamer, the gaming session begins. Throughout the gaming session, information and data is continually sent to the gaming and reward/fee management features of the session management subsystem. For example, as previously described above, throughout the game the fee tracking features of the session management subsystem keep track of the time spent and, therefore, the amount of money that is being deducted from the gamer's smart card. The deduction process may be based on time, number of games, performance etc. At the same time, the gamer may be earning reward points based on his activities and/or performance. Specifically, the reward point features of the session management subsystem keep track of the gamer's performance and add an applicable number of reward points to his account. Again, the addition process may be based on time, number of games, performance, etc.

Once the game or gaming session is complete, the results of the game and gamer need to be collected and his account and/or profile updated. The session management subsystem preferably includes the necessary features for interfacing with the games or applications offered within the Interactive Service Facility. One of ordinary skill in the art would realize that computer and console games typically provide and publish application programming interfaces (APIs) that will allow access to any one of the different gaming and performance statistics offered by the game. For example, this may include not only the winner and final score of a game, but also the highest shooting percentage, quickest lap time, etc. When the appropriate APIs are provided, the session management system automatically interfaces with the game to gather all of the applicable statistics that are then stored and sent on to the central server where they can be associated with the respective profiles and accounts of the gamers. If a particular game does not provide the necessary APIs to automatically access this information, then it is possible to have the individual gamers provide the statistics themselves to an administrator of the Interactive Service Facility. If necessary, a system can be established where it is the responsibility of one of the gamers to provide those statistics to the administrator who will then validate them with the other gamers.

d. Ranking Management

One important component of interactive gaming is ranking, which has been referred to at various stages throughout the description of the present invention. Ranking allows gamers to have an objective measure of their performance against the game and other players. Referring again to FIG. 10e, the ranking subsystem has previously obtained and put into memory 1025e the rankings of each gamer upon the user's access 1027e of the competitive multi-party interactive service. In a presently preferred embodiment, new gamers are assigned the rank of a beginner when the access a new game or service for the first time. Once a gamer terminates 1029e his involvement in the service, the ranking subsystem adjusts 1031e the previously recorded ranks to reflect the success or failure of the monitored gamer in the interactive game. One of ordinary skill in the art would appreciate that any methodology can be used to calculate the respective rankings of each user, including straight win-loss percentages or percentages adjusted for age or other weighting factors. Moreover, different ranking systems may be used for particular games or applications, or across different games or applications. The ranking subsystem then communicates 1043e the new rankings to the session management system.

As can be appreciated, the gaming and performance statistics and data gathered by the session management system may allow for very sophisticated rankings if desired. For example, when the appropriate APIs are present in a game, the ranking subsystem may access the relevant statistics stored within the session subsystem and determines the winner based on a predefined ranking algorithm. The ranking algorithm may include multiple variables and weight each of those variables differently. Examples of such weighting may include crediting a gamer more for a winning margin greater than a specific number or more for beating a higher ranked opponent than for beating a lower ranked opponent. For example, suppose a gamer ranked number 80 in a specific game successfully defeats an opponent that is ranked number 10 in the same game and does so very convincing (e.g. by greater than 25 points). A ranking algorithm as described above may reward the winner for beating a higher ranked opponent very convincing and penalize the loser for lowing to a lower ranked opponent in such a matter, resulting a new rank for the winner of 45 and a new rank for the loser of 50. If the necessary APIs are not present, than it will be necessary to implement a manual reporting system for the statistics, where the loser is expected to report the relevant statistics (winner, loser, how much) to an administrator of the Interactive Service Facility. As previously noted, if necessary, the winner will be provided access to this report and have the opportunity to challenge or correct any of the reported statistics. Once the report has been approved, the new ranking can be calculated as described above.

4. Providing Targeted Marketing and Sales Opportunities In Connection With An Interactive Gaming Service.

One of the unique aspects of the Interactive Service Facility of the present invention is the opportunity to collect rich and valuable data and information about a targeted demographic. Because of the networked capabilities of the Interactive Service Facility described above, all of the activities of gamers within the Interactive Service Facility can be tracked, monitored, stored and manipulated by the central server. The resulting information and data that is collected provides for unique marketing and sales opportunities for the Existing Facility. This information and data may be used internally by the Existing Facility to offer more personalized services to visitors and gamers, as well as offered to third parties, such as game and device makers or other sponsors that would be interested in the gaming demographic. Thus, marketing and surveying programs can be implemented to gather data about users coupled with concessions and promotional schemes that not only induce users to participate in the surveys but also encourage increased usage of the facilities and services offered within and/or outside the interactive services facility.

Some of this information and data will be automatically collected during the gaming activities of the gamers at the Interactive Gaming Stations. For example, the types of games and other applications that specific segments of the gaming demographic prefer. This might include, for example, the types of games and applications that specific genders, age groups or geographic areas prefer. Other information and data can be specifically collected through additional proactive activities of the Existing Facility. For example, the Existing Facility can request that gamers fill out conventional surveys or participate in evaluations and demonstrations of new games. If necessary, the Existing Facility may provide incentives for visitors and gamers to provide this information. Such incentives could include free entry into the arena, free games or additional time during a gaming session, or reward points that can be used within the Existing Facility or with specific third parties.

In a preferred example, a promotional database of marketing/survey programs and the associated promotional/inducement schemes is resident, for example, on computers within the server room. Thus, when a user uses a smart card to access the gaming station, the smart card reader reads the card, identifies the user by his age, sex and/or other demographic information and uses this information to access the promotional database and direct a set of offers and schemes to the user. Exemplary offer schemes could include asking the user to watch a video about a product, say from Microsoft, and earn ten minutes of free play, or watch a video about Nike and fill out a survey and get twenty minutes of free play. A user can choose the “deals of the day” either before beginning to play or at any time during play by clicking a related icon or button provided on the networking device at the gaming stations.

This information can be used to provide personalized marketing messages to visitors and gamers within the arena. For example, targeted advertisements can be provided on dedicated sections of the monitor at each Interactive Gaming Station based on the profile of the gamer that registers at that station. If a gamer is a male that is playing an adventure game, the network may elect to serve up an advertisement for a future adventure gaming tournament at the Facility. Similarly targeted, contextual commerce opportunities can be leveraged using the data collected by the network. For example, if a gamer is playing a baseball game at one of the Interactive Gaming Stations, the network may elect to serve up an advertisement or offer to purchase tickets to an upcoming baseball game at a local stadium, or official baseball jerseys or other similar collectables of the local baseball team. One of ordinary skill in the art would realize that any one of many conventional means might be used to provide these advertisements or offers through the Interactive Gaming Stations. For example, the offer may take the form of a banner advertisement that appears during a gaming session. Alternatively, the offer may be presented to the gamer once the gaming session has ended but before the gamer elects to log out of the system.

The Interactive Service Facility may elect to enter into various business relationships with related third party organizations that are interested in targeting the online gaming demographic. These relationships may take the form of conventional affiliate relationships, whereby the Interactive Service Facility serves as an online affiliate of the third party and shares in any revenue generated by the third party from transactions that are initiated through an Interactive Gaming Facility. As a result, the Interactive Service Facility may desire to have its own standard electronic commerce system that is integrated with its network, or may additionally or alternatively elect to interface the electronic commerce systems of related third parties through the Internet.

Moreover, the Interactive Service Facility preferably will integrate its smart card system into any electronic commerce systems that it utilizes so that gamers will be able to use their smart card to make these and other purchases, either using any cash or monetary balances remaining on their card or by using the reward points provided for by the Interactive Service Facility and any third party partners. Again, the Interactive Service Facility or any third party partners may elect to provide additional incentives, in the form of an affinity program and/or reward points, to encourage gamers to use their smart card to make such purchase or to purchase additional interactive services. Encouraging gamers to use their smart card for such purchases will allow the Interactive Service Facility to track, collect and analyze additional data and information on its target demographic. Credit/debit cards or other conventionally accepted forms could alternatively be utilized to make such purchases through the network.

5. Monitoring Usage of Interactive Gaming Services

As previously noted, interactive gaming includes a social aspect. While the interactive gaming service will be directly delivered to users through the Interactive Gaming Stations, it is also preferable to use the central screen 307 to display portions of the interactive gaming service activity. Thus, gamers are able to watch the games and other services on the displays at their own stations, and can also watch the activities around the gaming arena or the activities of other games on the big screen. By using a large screen to highlight or accentuate various user activities, a more engaging service environment is created. In accordance with one embodiment of the present invention, it is preferred to display the games of the best gamers on the big screen, so that all gamers can watch. It is also preferred to display the efforts of the best gamers on the Internet. In accordance with another aspect of the present invention, it is preferred to allow gamers to see themselves on the big screen. It is preferred to provide gamers with the ability to enable or disable this feature at their stations.

In accordance with yet another aspect of the present invention, it is preferred to allow parents to use the Internet to monitor the gaming arena. The location and activities of any particular gamers may be tracked and monitored by the Interactive Service Facility via the usage of the smart cards. As a result, the Interactive Service Facility may offer concerned parents the option of providing certain restrictions on the activities of their children within the arena. For example, a parent may desire to limit or restrict the access of their children to certain games or certain types of games. Many games now implement a rating system that provides information on the type or characteristics of the game (e.g. includes excessive violence). In a presently preferred embodiment, the Interactive Service Facility offers parents the ability to assign certain restrictions to their children's accounts or profiles. These restrictions may be specified at the time the children's profile is created with the Interactive Service Facility, or the Interactive Service Facility may provide a password-protected website where parents can log-in, access and change their child's profile by adding or modify a restriction. This will allow, for example, a parent to specify that their child should not be allowed to access, check-out or play any games with excessive violence. This restriction will be stored with the child's profile in the central server and associated with any smart card that is issued to the child within the Interactive Service Facility.

Another feature that may be offered to concerned parents through the same website of the Interactive Service Facility is the ability to monitor their children's activities in real-time. For example, as previously mentioned, each network access device includes a web camera. A parent desiring to monitor their children can access the website and enter their child's name or other identification means. Accessing the central server, the Interactive Service Facility network will be able to identify and locate the child at any time if they are logged into a network access device or if they are using their smart card within the arena. If the child is using a network access device, the parent may be prompted to select whether they want to see a real-time streaming video of their child through the web camera on their Interactive Gaming Station. Obviously, other activities of the child within the arena may additionally or alternatively be monitored by their parent if so desired. For example, by accessing a log or history of the child's use of his smart card, the parent will be able see all of the child's activities within the arena.

6. Providing Related Services Within the Interactive Service Facility

One of ordinary skill in the art would realize that there are any numbers of related services that may be additionally or alternatively provided by the Existing Facility within the Interactive Service Facility. For example, in one embodiment of the present invention, Interactive Service Facilities provide game training at the re-purposed movie theater complex. A gaming instructor can provide an instruction to gamers, on a fee basis, which is preferably charged to the gamer's account. The provision of this service to gamers will help gamers improve their rankings and will help introduce them to new games more quickly. It is also preferred to provide waiter service within the re-purposed gaming area. The gamers will appreciate this service and will also help the movie theater complex sell more concessions. The operator of the re-purposed gaming arena will preferably participate in a share of the concession sales by the movie theater complex, and particularly with respect to those sales generated by the waiter service. To facilitate concession sales, a presently preferred embodiment of the invention includes a concession purchasing system integrated within the Interactive Service Facility network that allows gamers to automatically order and purchase concessions directly from their Interactive Gaming Station. The concession purchasing system is preferably integrated into the waiter service so that any concessions ordered and purchased by a gamer are automatically delivered to his or her Interactive Gaming Station by a waiter, vendor or other employee of the facility, without requiring him or her to leave the gaming station.

In another embodiment, users can buy concession coupons from the control counter. The discount, being offered through the coupon, could be further linked to criteria such as the rank or frequency of visit of the user to the interactive services facility, granting higher discounts to frequent gamers and/or high ranked gamers in comparison to others. The concession coupons allow users to buy existing facility coupons at rates cheaper than standard, listed rates.

While various embodiments of the present invention have been shown and described, it would be apparent to those skilled in the art that many modifications are possible without departing from the inventive concept disclosed herein. For example, although the present invention has been described and illustrated using movie theaters as the Existing Facilities, those skilled in the art should realize that any physical structure with an existing AV infrastructure could be used. Additionally, while specific types of physical modifications and operational systems have been described, those skilled in the art should realize that other suitable modifications and operational systems, which address the primary functional requirements, could be used.

Furthermore, although embodiments of the network access devices of the present invention have been primarily described and illustrated as personal computers and/or gaming device consoles, one of ordinary skill in the art would realize that other types of devices that allow for single or multiplayer gaming interaction may additionally or alternatively be utilized. For example, there is an emerging group of gaming platforms that include mobile systems deployed via personal digital assistants (PDAs), cellular telephones or other mobile devices with infrared, cable network or telecommunication multiplayer interaction. Therefore, the Interactive Gaming Stations of the present invention may be modified to accommodate these gaming platforms and mobile systems as desired.

Moreover, one of ordinary skill in the art would realize that the infrastructure and network provided for in the Interactive Service Facility could additionally or alternatively be utilized for other related services. For example, by providing or integrating with an Internet Service Provider (ISP), the Interactive Service Facility could use its central server and network to deliver a gaming experience directly to gamers external to the facility. External gamers would dial-up or otherwise connect (e.g. via a wireless connection) with the central server and have access to the games and other applications on that server just as they would have through a traditional ISP and other online gaming services. It is therefore to be understood that this invention may be practiced otherwise than as specifically described.

We claim:

1. A gaming station for providing at least one user access to a plurality of games comprising:
a top surface having a plurality of access ports;
a plurality of side walls, connected to the top surface, having a plurality of access ports; and
an internal compartment, defined by said top surface and at least one of said plurality of side walls, for containing at least two computers.

2. The gaming station of claim 1 wherein the user can access at least one of said computers by entering through at least one of said access ports.

3. The gaming station of claim 2 wherein the at least one computer is a console based game device.

4. The gaming station of claim 3 wherein the user accesses the console based game device to load a game.

5. The gaming station of claim 2 wherein the user accesses the computer by sliding a door open.

6. The gaming station of claim 2 wherein the user accesses the computer by pulling a door open.

7. The gaming station of claim 2 wherein the access port comprises a locking mechanism.

8. The gaming station of claim 2 wherein the user retrieves a controller through an access port in the top surface.

9. The gaming station of claim 8 wherein the controller is a joystick.

10. The gaming station of claim 9 wherein the controller is a mouse.

11. The gaming station of claim 2 wherein one of said computers is a console-based gaming device and a second of said computers is a control unit.

12. The gaming station of claim 11 wherein the control unit is a personal computer.

13. The gaming station of claim 11 wherein the control unit is in data communication with a card reader.

14. The gaming station of claim 13 wherein the card reader is accessed through an access port.

15. The gaming station of claim 11 wherein the control unit is in data communication with a monitor.

16. The gaming station of claim 15 wherein the control unit activates the monitor to display data received by said console based gaming device when the control unit is activated by the user.

17. The gaming station of claim 16 wherein the control unit is activated by the user inserting a card into a card reader.

18. The gaming station of claim 1 further comprising a leg extension space under the top surface and proximate to at least one said side walls.

19. The gaming station of claim 1 wherein the user can access a plurality of interfaces for at least one of said computers through at least one of said plurality of access ports.

20. The gaming station of claim 19 wherein the user can physically connect devices to said interfaces.

21. The gaming station of claim 1 wherein the top surface and said plurality of side walls are comprised of metal.

22. The gaming station of claim 21 wherein the top surface and said plurality of side walls have rounded edges.

23. The gaming station of claim 1 wherein the internal compartment has a cooling system.

24. The gaming station of claim 23 wherein said cooling system comprises a plurality of spaces in the side walls.

25. The gaming station of claim 1 wherein the top surface is coated with an insulating material.

26. The gaming station of claim 1 further comprising an audio routing switch.

27. The gaming station of claim 1 further comprising a monitor located on the top surface.

28. A method of modifying aisle space in a theater having stratified seating wherein a first row, having a plurality of fixed seats, is lower in elevation relative to a second row, having a plurality of fixed seats and wherein the first row and the second row are separated by a first aisle space, comprising the steps of:
removing the plurality of fixed seats from the first row;
removing the plurality of fixed seats from the second row;
installing a platform structure that increases the first row elevation; and
inserting a plurality of interactive service stations in said first row and in said second row wherein the first row and the second row are separated by a second aisle space and wherein the second aisle space is greater than the first aisle space.

29. The method of claim 28 wherein the interactive service station comprises:
a top surface having a plurality of access ports;
a plurality of side walls, connected to the top surface, having a plurality of access ports; and
an internal compartment, defined by said top surface and at least one of said plurality of side walls, for containing a plurality of computers.

30. The method of claim 28 wherein the platform structure has an access port through which areas under the platform can be accessed.

31. A method of modifying aisle space in a theater wherein a first row, having a plurality of seats, is separated from a second row, having a plurality of seats, by a first aisle space, comprising the steps of:
removing the plurality of seats from the first row;
removing the plurality of seats from the second row; and
inserting a plurality of gaming stations in said first row and in said second row wherein the first row and the second row are separated by a second aisle space and wherein the second aisle space is greater than the first aisle space.

32. A modified theater for the provision of interactive services to a plurality of users, comprising:
a back wall;
a front wall having a wide-area screen wherein said screen has a base area, two side areas, and a top area;
a floor;
a plurality of side walls in physical communication with said back wall and said front wall;
a monitoring station proximate to said front wall;
a plurality of gaming stations, each having at least one computer, dispersed throughout the theater; and
an event area for the staging of interactive service events.

33. The modified theater of claim 32 wherein the event area is elevated relative to the floor.

34. The modified theater of claim 33 wherein the event area is proximate to the back wall.

35. The modified theater of claim 33 wherein the event area is proximate to the front wall.

36. The modified theater of claim 32 wherein gaming competitions between a plurality of users are conducted in the event area.

37. The modified theater of claim 32 wherein the event area is enclosed by a fence.

38. The modified theater of claim 37 wherein the fence comprises a plurality of metallic stands and metallic wire extending from a first metallic stand to a second metallic stand.

39. The modified theater of claim 32 wherein the gaming stations comprise:
a top surface having a plurality of access ports;
a plurality of side walls, connected to the top surface, having a plurality of access ports; and
an internal compartment, defined by said top surface and at least one of said plurality of side walls, for containing at least two computers.

40. The modified theater of claim 39 wherein the user can access at least one of said computers by entering through at least one of said access ports.

41. The modified theater of claim 40 wherein the at least one computer is a console based game device.

42. The modified theater of claim 41 wherein the user accesses the console based game device to load a game.

43. The modified theater of claim 40 wherein the user accesses the computer by sliding a door open.

44. The modified theater of claim 40 wherein the user accesses the computer by pulling a door open.

45. The modified theater of claim 40 wherein the access port comprises a locking mechanism.

46. The modified theater of claim 40 wherein the user retrieves a controller through an access port in the top surface.

47. The modified theater of claim 46 wherein the controller is a joystick.

48. The modified theater of claim 47 wherein the controller is a mouse.

49. The modified theater of claim 41 wherein one of said computers is a console-based gaming device and a second of said computers is a control unit.

50. The modified theater of claim 49 wherein the control unit is a personal computer.

51. The modified theater of claim 49 wherein the control unit is in data communication with a card reader.

52. The modified theater of claim 51 wherein the card reader is accessed through an access port.

53. The modified theater of claim 51 wherein the control unit is in data communication with a monitor.

54. The modified theater of claim 53 wherein the control unit activates the monitor to display data received by said console based gaming device when the control unit is activated by the user.

55. The modified theater of claim 54 wherein the control unit is activated by the user inserting a card into a card reader.

56. The modified theater of claim 39 wherein the user can access a plurality of interfaces for at least one of said computers through at least one of said plurality of access ports.

57. The modified theater of claim 56 wherein the user can physically connect devices to said interfaces.

58. The modified theater of claim 57 wherein the devices are include at least one of a joystick, headphones, or a mouse.

59. The modified theater of claim 39 wherein the internal compartment has a cooling system.

60. The modified theater of claim 59 wherein said cooling system comprises a plurality of spaces in the side walls.

61. The modified theater of claim 32 further comprising a plurality of physical structures, having viewable surfaces, positioned at the base area of the screen.

62. The modified theater of claim 61 wherein the physical structures have printed messages on the viewable surfaces.

63. The modified theater of claim 32 further comprising a plurality of physical structures, having viewable surfaces, positioned at the side areas of the screen.

64. The modified theater of claim 63 wherein the physical structures have printed messages on the viewable surfaces.

65. The modified theater of claim 32 further comprising a plurality of physical structures, having viewable surfaces, positioned at the top area of the screen.

66. The modified theater of claim 65 wherein the physical structures have printed messages on the viewable surfaces.

67. The modified theater of claim 32 wherein a plurality of light sources is fixed on at least one of said plurality of side walls.

68. The modified theater of claim 67 wherein at least one of said plurality of light sources is focused on at least one gaming station.

69. The modified theater of claim 32 wherein the monitoring station is proximate to a plurality of servers.

70. The modified theater of claim 69 wherein the plurality of servers is in data communication with the at least one computer in each of said plurality of gaming stations.

71. The modified theater of claim 32 further comprising an age restricted area proximate to the front wall.

72. The modified theater of claim 32 further comprising a plurality of aisles, each having a width, defined by said gaming stations.

73. The modified theater of claim 72 wherein the width of each aisle is greater than one-half seat length.

74. A facility for the provision of interactive services to a plurality of users, comprising:
a plurality of gaming stations arranged in a plurality of rows;
a floor having at least two different elevations wherein said floor operates as a foundation for each of said rows of gaming stations; and
a front wall having a projection screen.
